(19) United States
(12) Patent Application Publication
(10) Pub. No.: US 2023/0036326 A1
(43) Pub. Date: Feb. 2, 2023

(54) IMAGE DISPLAY APPARATUS

(71) Applicant: SONY GROUP CORPORATION, Tokyo (JP)

(72) Inventors: Kazue SHIMIZU, Tokyo (JP); Ryo KASEGAWA, Tokyo (JP); Satoshi MITANI, Tokyo (JP)

(73) Assignee: SONY GROUP CORPORATION, Tokyo (JP)

(21) Appl. No.: 17/792,789

(22) PCT Filed: Jan. 8, 2021
(86) PCT No.: PCT/JP2021/000469

§ 371 Date: Jul. 14, 2022

(30) Foreign Application Priority Data
Jan. 22, 2020 (JP) 2020-008397

(51) Int. Cl. G02B 27/01; G02B 27/42

(52) U.S. Cl. CPC G02B 27/0103; G02B 27/4205

(57) ABSTRACT

An image display apparatus according to an embodiment of the present technology includes a first screen and a second screen. The first screen includes an image surface on which an object image is formed, the first screen obliquely projecting the object image from the image surface. The second screen includes an incident surface that is arranged parallel to the image surface and on which image light of the object image is incident, the second screen diffracting the image light in an exit direction different from a specular-reflection direction that corresponds to a direction of incidence of the image light on the incident surface, the second screen forming a virtual image parallel to the object image.

### TECHNICAL FIELD

The present technology relates to an image display apparatus that displays a virtual image.

### BACKGROUND ART

Patent Literature 1 discloses a head-up display (HUD) that displays a virtual image. In the HUD, light emitted from an information display source is diffracted by a combiner, and is displayed in the form of a virtual image to an observer situated at a specified position. The light emitted from the information display source is incident on the combiner through a fold mirror, and is reflectively diffracted to be headed for the observer. The combiner is arranged orthogonal to an optical axis (a line of sight of the observer) that connects the observer and the virtual image. Consequently, the observer views the combiner from the front, and this results in reducing a feeling of strangeness with respect to display of the virtual image (for example, paragraphs [0014], [0023], and [0024] in the specification and FIG. 1 in Patent Literature 1).

### CITATION LIST

### Patent Literature

Patent Literature 1: Japanese Patent Application Laid-open No. 10-48562

### DISCLOSURE OF INVENTION

### Technical Problem

There is a need for a technology that makes it possible to provide various information presentations and viewing experiences by displaying a virtual image to an observer, as described above, and to make an apparatus smaller in size and perform display of a virtual image with a sense of reality.

In view of the circumstances described above, it is an object of the present technology to provide an image display apparatus that makes it possible to make an apparatus smaller in size and perform display of a virtual image with a sense of reality.

### Solution to Problem

In order to achieve the object described above, an image display apparatus according to an embodiment of the present technology includes a first screen and a second screen.

The first screen includes an image surface on which an object image is formed, the first screen obliquely projecting the object image from the image surface.

The second screen includes an incident surface that is arranged parallel to the image surface and on which image light of the object image is incident, the second screen diffracting the image light in an exit direction different from a specular-reflection direction that corresponds to a direction of incidence of the image light on the incident surface, the second screen forming a virtual image parallel to the object image.

In the image display apparatus, the object image formed on the image surface of the first screen is obliquely projected. The second screen diffracts the image light of the object image incident on the incident surface parallel to the image surface to form the virtual image parallel to the object image. Here, the image light is diffracted in an exit direction different from a specular-reflection direction that corresponds to an incident direction. Consequently, the virtual image displayed in parallel with the second screen can be observed from a direction that is different from a direction in which the image light is specularly reflected. Accordingly, it is possible to make the apparatus smaller in size, and to perform display of a virtual image with a sense of reality.

### BRIEF DESCRIPTION OF DRAWINGS

FIG. 1 schematically illustrates a basic configuration of an image display apparatus according to a first embodiment of the present technology.

FIG. 2 schematically illustrates an enlarged portion of a side view of the image display apparatus illustrated in A of FIG. 1.

FIG. 3 schematically illustrates an example of a configuration of a reflective hologram.

FIG. 4 is a schematic diagram used to describe a relationship between a position of a virtual image displayed by a virtual-image screen and an observation direction.

FIG. 5 schematically illustrates an example of the virtual image displayed by the virtual-image screen.

FIG. 6 is a set of graphs illustrating a change in virtual image depending on an elevation angle corresponding to an observation direction.

FIG. 7 is a set of graphs illustrating a change in virtual image depending on an azimuth angle corresponding to an observation direction.

FIG. 8 is a schematic diagram used to describe a relationship between a display elevation range and an exit angle.

FIG. 9 illustrates an example of a diffraction-efficiency elevation range depending on a slant angle.

FIG. 10 illustrates an example of the diffraction-efficiency elevation range depending on the slant angle.

FIG. 11 is a graph illustrating an absolute value of a value obtained by differentiating an angle of incidence twice with respect to an exit angle.

FIG. 12 schematically illustrates a specific example of the configuration of the image display apparatus.

FIG. 13 schematically illustrates examples of configurations of a real-image screen.

FIG. 14 schematically illustrates another example of the configuration of the real-image screen.

FIG. 15 schematically illustrates examples of arrangements of the real-image screen.

FIG. 16 illustrates a change in virtual image on a hologram screen of a comparative example.

FIG. 17 illustrates a change in virtual image on the hologram screen of the comparative example.

FIG. 18 schematically illustrates an example of a configuration of an image display apparatus according to a second embodiment.

FIG. 19 schematically illustrates an example of a configuration of an image display apparatus according to a third embodiment.

FIG. 20 schematically illustrates an example of a configuration of an image display apparatus according to a fourth embodiment.

FIG. 21 schematically illustrates examples of configurations of virtual-image screens according to other embodiments.

FIG. 22 is a set of maps of examples of distributions of diffraction efficiencies of a virtual-image screen.

FIG. 23 schematically illustrates an example of a reflective hologram in a rotation arrangement.

FIG. 24 schematically illustrates an example of a configuration of an image display apparatus using the reflective hologram in the rotation arrangement.

FIG. 25 schematically illustrates another example of the configuration of the image display apparatus using the reflective hologram in the rotation arrangement.

### MODE(S) FOR CARRYING OUT THE INVENTION

Embodiments of the present technology will now be described below with reference to the drawings.

### First Embodiment

[Configuration of Image Display Apparatus]

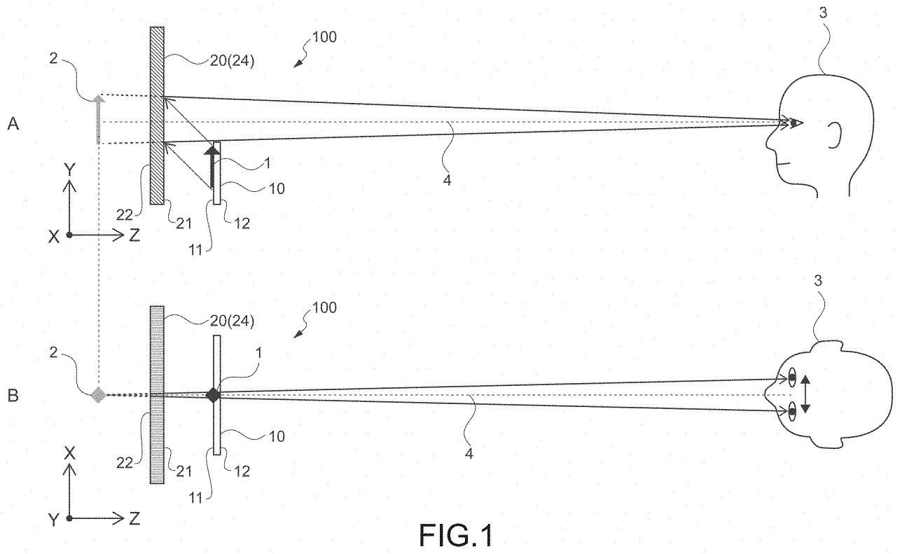

FIG. 1 schematically illustrates a basic configuration of an image display apparatus according to a first embodiment of the present technology. A and B of FIG. 1 are a side view and a top view of an image display apparatus 100. The image display apparatus 100 is an apparatus that diffracts image light that makes up an object image 1, and displays a virtual image 2 of the object image 1.

The image display apparatus 100 includes a real-image screen 10 and a virtual-image screen 20, and displays, as the virtual image 2 and through the virtual-image screen 20, the object image 1 formed on the real-image screen 10. Here, the object image is an image of a target image that is a display target, and is typically a video.

Pieces of diffused light (image light) with which pixels of the object image 1 are displayed, exit from respective points on the real-image screen 10. Thus, it can be said that the object image 1 is a real image formed on the real-image screen 10.

The image light of the object image 1 (a real image) is diffracted by the virtual-image screen 20 to form the virtual image 2. This enables a user 3 to observe the virtual image 2 of the object image 1 through the virtual-image screen 20.

A of FIG. 1 schematically illustrates the object image 1 and the virtual image 2 respectively using black and gray arrows. Further, B of FIG. 1 schematically illustrates the object image 1 and the virtual image 2 of A of FIG. 1 respectively using black and gray rhombuses. From among those images, the user 3 observes the virtual image 2 represented by the gray arrow or the gray rhombus.

The virtual image 2 illustrated in A and B of FIG. 1 is an image that is visually recognized by the user 3 when the user 3 is observing the virtual-image screen 20 along a standard observation axis 4 (hereinafter referred to as being in a standard observation state). The image display apparatus 100 is designed on the assumption of such a standard observation state.

Note that the virtual image 2 can also be visually recognized when the virtual-image screen 20 is observed from a direction that is different from a direction of the standard observation axis 4. In this case, there may be a change in, for example, the position of the virtual image 2 from the case of being in the standard observation state. In the present disclosure, the image display apparatus 100 is configured such that a change in, for example, the position of the virtual image 2 (a change in virtual image) that is caused due to such a difference in observation direction, is suppressed.

The real-image screen 10 includes a first surface 11 and a second surface 12. The first surface 11 is a surface on which the object image 1 is formed, and is a surface that image light 5 of the object image 1 exits. The second surface 12 is a surface that is situated opposite to the first surface 11. The real-image screen 10 is arranged such that the first surface 11 faces the virtual-image screen 20. Further, the real-image screen 10 is typically in the form of a flat plate, and the first surface 11 and the second surface 12 are both flat. In the present embodiment, the first surface 11 corresponds to an image surface.

The real-image screen 10 obliquely projects the object image 1 from the first surface 11. A projection direction in which the object image is projected from the first surface 11 is set together with the configuration of the virtual-image screen 20, such that, for example, the object image 1 and the virtual image 2 do not overlap.

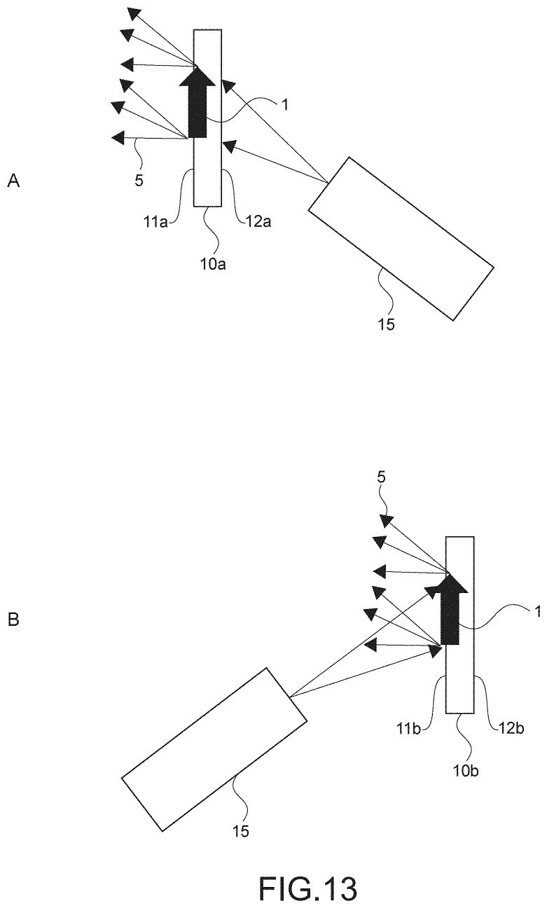

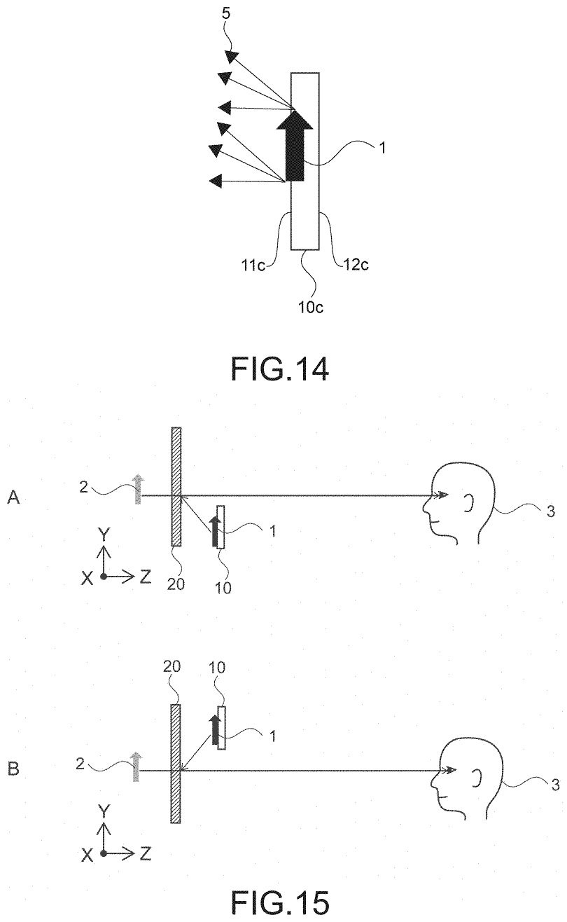

For example, a screen that diffuses projected light to form the object image 1, or a display that directly displays the object image 1 is used as the real-image screen 10 (for example, refer to FIGS. 13 and 14).

Pieces of diffused light (image light) with which pixels, of the object image 1, that correspond to respective points of the first surface 11 are displayed, exit from the respective points. From among the diffused light, a ray that exits in the projection direction is hereinafter referred to as a principal ray. In other words, the projection direction is a direction in which a principal ray of diffused light is projected. For example, setting is performed such that the intensity of a principal ray is highest in a diffusion distribution of diffused light. This makes it possible to project a bright object image 1 in a desired direction, and thus to improve the brightness of the virtual image 2.

In the present embodiment, the real-image screen 10 is arranged on the side of a surface (a third surface 21) of the virtual-image screen 20 that faces the user 3, as illustrated in FIG. 1. Specifically, the real-image screen 10 is arranged diagonally below a region on the third surface 21, the region being a region onto which the image light 5 of the object image 1 is projected. This makes it possible to provide a configuration in which the virtual image 2 is displayed on an upper portion of the image display apparatus 100, and the real-image screen 10 and other optical systems are accommodated in a lower portion of the image display apparatus 100. Further, the real-image screen 10 is arranged to avoid a path of the image light 5 with which the virtual image 2 is displayed. This makes it possible to prevent the virtual image 2 from being blocked by the real-image screen 10.

In the present embodiment, at least one single-wavelength light source that emits light of a different wavelength is used as a light source of the image light 5. Here, the light source of the image light 5 is, for example, a light source of a projector, or a backlight of a display. Further, the single-wavelength light source is, for example, a light source that emits one-color visible light of a narrow wavelength width.

For example, when an image is displayed in one color, a light source that emits light in the color is used. Further, when a color image is displayed, light sources that respectively emit pieces of light of colors of R, G, and B are used. The wavelength and the like of the single-wavelength light source are not limited. Note that the virtual-image screen 20 is configured such that the virtual-image screen 20 can properly diffract the pieces of light of those wavelengths (the image light 5).

For example, a laser source using, for example, a laser diode (LD) is used as such a light source. The use of a laser source makes it possible to improve the brightness of the virtual image 2.

Further, at least one narrowband light source that emits light of a different wavelength may be used as the light source of the image light 5. The narrowband light source is, for example, a light source that can emit one-color visible light of a narrow wavelength bandwidth. The narrowband light source has a wider wavelength width than a single-wavelength light source such as a laser source, and has a narrower wavelength width than visible light generated through, for example, a phosphor or a color filter.

A light-emitting element such as a superluminescent diode (SLD) or a light-emitting diode (LED) is used as the narrowband light source. When a narrowband light source is used, a sufficient diffraction efficiency can also be obtained since the narrowband light source has a narrow wavelength width.

Moreover, for example, a light source that generates visible light through a phosphor, or a mercury lamp may be used.

Further, for example, a light source of a relatively wide wavelength width, such as a narrowband light source, may be used in combination with a narrowband bandpass filter that limits a band of light. This makes it possible to use, for example, an LED, and thus to reduce apparatus costs.

The above-described use of light of a narrowband single wavelength makes it possible to control a traveling direction (a diffraction direction) of the image light 5 diffracted by the virtual-image screen 20 with a high degree of accuracy. This makes it possible to sufficiently prevent blur in the virtual image 2 from being caused due to wavelength dispersion, and thus to enhance the resolution of display of a virtual image.

The virtual-image screen 20 diffracts the image light 5 of the object image 1 projected by the real-image screen 10 to form the virtual image 2 of the object image 1.

The virtual-image screen 20 includes the third surface 21 and a fourth surface 22. The third surface 21 is a surface that is arranged parallel to the first surface 11 and on which the image light 5 of the object image 1 is incident. The fourth surface 22 is a surface that is situated opposite to the third surface 21. The virtual-image screen 20 is arranged such that the third surface 21 faces the user 3. In the present embodiment, the third surface 21 corresponds to an incident surface. Further, the virtual-image screen 20 is in the form of a flat plate, and the third surface 21 and the fourth surface 22 are both flat.

The image light 5 incident on the third surface 21 is diffracted by the virtual-image screen 20, and exits the third surface 21. In other words, the virtual-image screen 20 is a reflective screen off which the image light 5 incident on the third surface 21 is reflected.

A plane parallel to the third plane 21 (the virtual-image screen 20) is hereinafter referred to as an XY plane. In this plane, a lateral direction of the third surface 21 is referred to as an X direction, and a longitudinal direction of the third surface 21 is referred to as a Y direction. Further, a direction orthogonal to the third surface 21 (the XY plane) is referred to as a Z direction. Note that the side view and the top view illustrated in A and B of FIG. 1 are schematic diagrams of the image display apparatus 100 as viewed in the X direction and in the Y direction.

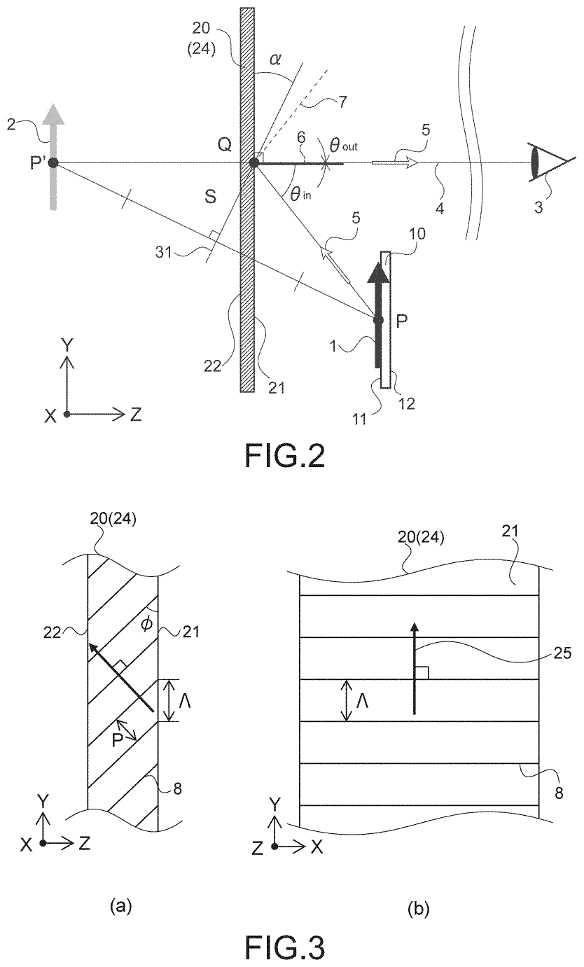

FIG. 2 schematically illustrates an enlarged portion of the side view of the image display apparatus 100 illustrated in A of FIG. 1. FIG. 2 schematically illustrates, using white arrows, an incident direction and an exit direction of the image light 5 relative to the virtual-image screen 20 (the third surface 21).

Here, the incident direction of the image light 5 is, for example, a direction in which a principal ray is incident on the third surface 21, and a direction parallel to the direction of projection of the image light 5 that is performed by the real-image screen 10 (the first surface 11). Further, the exit direction is, for example, a direction in which the principal ray is reflected off (diffracted by) the third surface 21 to exit the third surface 21, and is a direction of diffraction performed by the virtual-image screen 20.

For example, a direction parallel to the exit direction is set to be the standard observation axis 4. Alternatively, a direction different from the exit direction may be set to be the standard observation axis 4. This will be described later.

In the following description, an angle formed by a normal 6 to the third surface 21 (a thick solid line in the figure) and a line corresponding to the incident direction of the image light 5 is referred to as an angle of incidence θᵢₙ of the image light 5 incident on the third surface 21. An angle formed by the normal 6 to the third surface 21 and a line corresponding to the exit direction of the image light 5 is referred to as an exit angle θₒᵤₜ of the image light 5 exiting the third surface 21.

The virtual-image screen 20 diffracts the image light 5 in the exit direction different from a specular-reflection direction 7 that corresponds to the direction of incidence of the image light 5 on the third surface 21 (the direction of projection of the image light 5 onto the third surface 21). For example, the image light 5 incident on the third surface 21 at the angle of incidence θᵢₙ exits in a direction different from a direction (the specular-reflection direction 7) in which the image light 5 is specularly reflected.

Here, the specular-reflection direction 7 is, for example, a direction in which light is reflected off a mirror surface of, for example, a mirror, and a reflection direction in which an angle of incidence and an exit angle upon reflection are equal. FIG. 2 schematically illustrates, using a dotted line, the specular-reflection direction 7 of the image light 5 incident on the third surface 21 at the angle of incidence θᵢₙ. Note that, when light is specularly reflected, a specular-reflection image of the object image 1 is displayed in the specular-reflection direction 7.

As illustrated in FIG. 2, the virtual-image screen 20 diffracts the image light 5 such that the angle of incidence θᵢₙ and the exit angle θₒᵤₜ of the image light 5 relative to the third surface 21 exhibit values different from each other. Thus, θᵢₙ≠θₒᵤₜ when diffraction is performed by the virtual-image screen 20.

The above-described diffraction of the image light 5 makes it possible to cause the image light 5 to exit in a direction other than the specular-reflection direction 7, and thus to display the virtual image 2 in a desired direction. Further, it can also be said that the virtual-image screen 20 is configured such that the specular-reflection image of the object image 1 and the virtual image 2 of the object image 1 do not overlap. This makes it possible to prevent a reflection due to, for example, specular reflection.

Further, the virtual-image screen 20 diffracts the image light 5 in the exit direction to form the virtual image 2 parallel to the object image 1.

For example, as illustrated in FIG. 2, the image light 5 (diffused light) exiting from a point P on the real-image screen 10 (the first surface 11) and entering the third surface 21 is diffracted by the virtual-image screen 20, and exits the third surface 21 to travel along a light path that connects an incident position Q on the third surface 21 and a point P′ (a virtual-image focal point) that is situated on the side of the fourth surface 22.

Consequently, upon observation, it looks like the image light 5 entering a pupil of the user 3 that is oriented toward a direction of the third surface 21 exits from the point P′ situated on the side of the fourth surface 22. Further, the image light 5 exiting from a point other than the point P′ is similarly diffracted to exit the third surface 21. Consequently, the virtual image 2 formed on the side of the fourth surface 22 is an image parallel to the object image 1.

As described above, the virtual image 2 is displayed parallel to the virtual-image screen 20, and this makes it possible to reduce an uncomfortable feeling brought to the user when, for example, the virtual image 2 is inclined with respect to the screen, and to perform display of a virtual image with a greater sense of reality.

Further, in the image display apparatus 100, the object image 1 (the real-image screen 10), the virtual-image screen 20, and the virtual image 2 are arranged parallel to each other, as illustrated in FIGS. 1 and 2. As described above, the screens can be arranged parallel to each other, and this makes it possible to obtain a compact apparatus configuration.

Further, the exit direction of the image light 5 (a direction in which the virtual image 2 is displayed) can be set discretionarily to be a direction different from the specular-reflection direction 7. This makes it possible to, for example, prevent the virtual-image screen 20 from being inclined with respect to a line of sight of the user 3. This results in improving a form factor of the apparatus, and thus in being able to make the apparatus smaller in size.

Note that, in the present disclosure, a state of “being parallel” includes a state of being substantially parallel, that is, a state of being almost parallel. For example, a state in which an amount (an angle) of deviation from a state of being completely parallel is within a specified angular range (for example, about +/−10 degrees), is a state of “being parallel”.

In the present embodiment, the exit direction of the image light 5 is set to be a direction orthogonal to the third surface 21. In other words, the exit direction is set to be a direction (the Z direction) parallel to the normal 6 to the third surface 21, and the exit angle θₒᵤₜ of the image light 5 diffracted by the virtual-image screen 20 is 0 degrees.

This makes it possible to display, to the user 3 viewing the virtual-image screen 20 from the front, the virtual image 2 parallel to the virtual-image screen 20, and thus to display a virtual image without bringing an uncomfortable feeling.

Further, in the present embodiment, the real-image screen 10 and the virtual-image screen 20 are arranged in a vertical direction, and the exit direction is set to be a horizontal direction. For example, the Y direction is the vertical direction in the example illustrated in FIGS. 1 and 2. Further, an XZ plane is a horizontal plane. In the present embodiment, the real-image screen 10 and the virtual-image screen 20 are vertically placed, and the object image 1 and the virtual image 2 are also vertically displayed, as described above. This makes it possible to display the vertically formed virtual image 2 to the user 3 viewing the virtual-image screen 20 from the horizontal direction.

Note that an orientation of the exit direction is not limited. For example, when the user 3 observes the apparatus from diagonally above, the exit direction can also be set to be oriented diagonally upward according to an observation direction of the user 3. Moreover, the exit direction may be set as appropriate according to, for example, the application of the apparatus.

[Configuration of Virtual-Image Screen]

The virtual-image screen 20 is formed using a reflective hologram 24.

The reflective hologram 24 is a reflective holographic optical element (HOE). The HOE is an optical element using a hologram technology, and a traveling direction of light (a light path) is controlled by the light being diffracted by an interference fringe recorded in advance.

The reflective hologram 24 is configured to diffract the image light 5 incident on the third surface 21 to cause the image light 5 to exit the third surface 21. Further, the reflective hologram 24 can control the exit direction. In the present embodiment, the reflective hologram 24 corresponds to a reflective diffractive optical element.

The reflective hologram is formed using, for example, a hologram material (such as a photopolymer) in the form of a film. In this case, the virtual-image screen 20 having the retainability and the durability can be formed by attaching the reflective hologram 24 to a transparent base material such as glass or plastics. Note that an illustration of the transparent base material is omitted in FIGS. 1 and 2.

In the above-described configuration in which the reflective hologram 24 is attached, it is sufficient if the reflective hologram 24 is attached to the front side when a layer of the transparent base material is not desired to be situated on the side of the user 3. This makes it possible to prevent, for example, light from being specularly reflected off the surface of the transparent base material. Further, it is sufficient if the reflective hologram 24 is attached to the back side when the reflective hologram 24 is not desired to be directly touched.

Further, for example, when the reflective hologram 24 has no adhesive properties or when the reflective hologram 24 with a higher degree of durability is considered, a configuration in which the reflective hologram 24 is sandwiched between transparent base materials may be adopted.

The reflective hologram 24 is configured such that light incident at an angle in a specific angular range is diffracted to be reflected off the reflective hologram 24, and such that light incident at an angle in an angular range other than the specific angular range is transmitted through the reflective hologram 24.

For example, the light incident on the third surface 21 at an angle in the specific angular range exits the third surface 21 at an exit angle that corresponds to the angle of incidence. The angle of incidence θᵢₙ of the image light 5 on the third surface 21 (an angle of projection of the image light 5 onto the third surface 21) is set to be within the angular range. Alternatively, the angular range is set such that θᵢₙ is within the angular range.

Further, the light incident at an angle in the angular range other than the specific angular range is transmitted through the reflective hologram 24 almost without being diffracted by an interference fringe. Thus, for example, light of a background that is incident from the side of the fourth surface 22 in the horizontal direction can pass without any change.

As described above, the reflective hologram 24 serves as a transparent screen. This makes it possible to display the virtual image 2 in a state of being superimposed on a real space, and thus to provide an excellent visual effect.

In the present embodiment, a volume phase hologram (a volume HOE) is used as the reflective hologram 24. The volume phase hologram is an HOE that only has the first order of diffraction and includes a hologram material (such as a photopolymer) in which interference fringes are recorded. Thus, the second- and higher-order of diffraction can be ignored in the case of the reflective hologram 24.

Further, the reflective hologram 24 is configured as a reflective mirror hologram that has no refractive power. In this case, the reflective hologram 24 may be considered a flat mirror off which light is reflected in a direction different from a direction of specular reflection.

For example, it is assumed that, as illustrated in FIG. 2, the image light 5 exiting from the point P on the first surface 11 and entering the point Q on the third surface 21 is diffracted to form the virtual image 2 of the point P at the point P′ situated on the side of the fourth surface 22. In this case, a line PQ has a length equal to the length of a line P′Q (PQ=P′Q), and a triangle PQP′ is an isosceles triangle.

FIG. 3 schematically illustrates an example of a configuration of the reflective hologram 24. (a) of FIG. 3 schematically illustrates a cross section in a thickness direction of the reflective hologram 24. (b) of FIG. 3 schematically illustrates the third surface 21 of the reflective hologram 24.

The reflective hologram 24 is an HOE that is exposed to light to generate interference fringes 8 having a period in a certain direction. Specifically, a plurality of strip-shaped interference fringes 8 parallel to each other is formed along the third surface 21 (the fourth surface 22). For example, a direction orthogonal to the respective interference fringes 8 formed parallel to each other is a direction in which the interference fringes 8 have the period (a period direction).

The interference fringes 8 serve as a one-dimensional diffraction grating. In other words, the reflective hologram 24 includes a one-dimensional diffraction grating. FIG. 3 schematically illustrates the interference fringes 8 formed in the reflective hologram 24 in a stripe pattern.

The pattern of the interference fringes 8 having a period in a certain direction (a one-dimensional diffraction grating) can be formed using, for example, scanning exposure that includes scanning laser light and generating interference fringes.

As illustrated in (a) of FIG. 3, the interference fringes 8 each having a slant angle φ are formed at regular intervals in the reflective hologram 24. Here, the slant angle φ is an angle formed by the interference fringe 8 and a surface of the reflective hologram 24 (the third surface 21 and the fourth surface 22). For example, light that enters the reflective hologram 24 is reflected at an angle corresponding to the angle of incidence and the slant angle φ. The slant angle φ can be set to be a desired angle by adjusting, for example, an angle of incidence of laser light upon performing exposure to the laser light to generate the interference fringes 8.

As described above, the interference fringes 8 form a one-dimensional diffraction grating in the reflective hologram 24. (a) of FIG. 3 schematically illustrates a grating vector 25 of the interference fringes 8 using a thick-line arrow. The grating vector 25 is a vector orthogonal to the respective interference fringes 8. A direction of the grating vector 25 corresponds to the direction of a period of the interference fringes 8.

In the present embodiment, the direction of the period of the interference fringes 8 on the third surface 21 is a direction obtained by orthogonally projecting the incident direction (the projection direction) onto the third surface 21.

For example, the direction obtained by orthogonally projecting the projection direction onto the third surface 21 is an up-and-down direction of the third surface 21 (the Y direction), as illustrated in FIG. 2. Thus, as illustrated in (b) of FIG. 3, the direction of the period of the interference fringes 8 on the third surface 21 (the direction of the grating vector 25 on the third surface 21) is the Y direction.

This results in, for example, the efficiency in diffracting the image light 5 exhibiting a bilaterally symmetrical distribution.

The reflective hologram 24 is exposed to light to generate the interference fringes 8 having the grating vector 25 (the slant angle φ) for performing diffraction with respect to the object image 1 in the exit direction (the exit angle θₒᵤₜ).

The period of the interference fringes 8 in the reflective hologram 24 is hereinafter referred to as a grating pitch P, and the period of the interference fringes 8 on the surface of the reflective hologram 24 is hereinafter referred to as a boundary pitch Λ. The grating pitch P is a pitch determined by a wavelength and an exposure angle of laser light upon performing exposure to the laser light to generate the interference fringes 8.

For example, a relationship between the angle of incidence θᵢₙ and the exit angle θₒᵤₜ of the image light 5 relative to the third surface 21 can be represented using a formula indicated below.

Sin θᵢₙ+/−mλ/Λ=Sin θₒᵤₜ (1)

Here, λ represents a primary wavelength of the image light 5 corresponding to a reconstruction light source, and m represents an integer that is greater than or equal to one.

The boundary pitch Λ and the slant angle φ can be set according to Formula (1) described above. Note that Formula (1) is a formula that represents the Bragg condition.

[Relationship Between Virtual Image and Observation Direction]

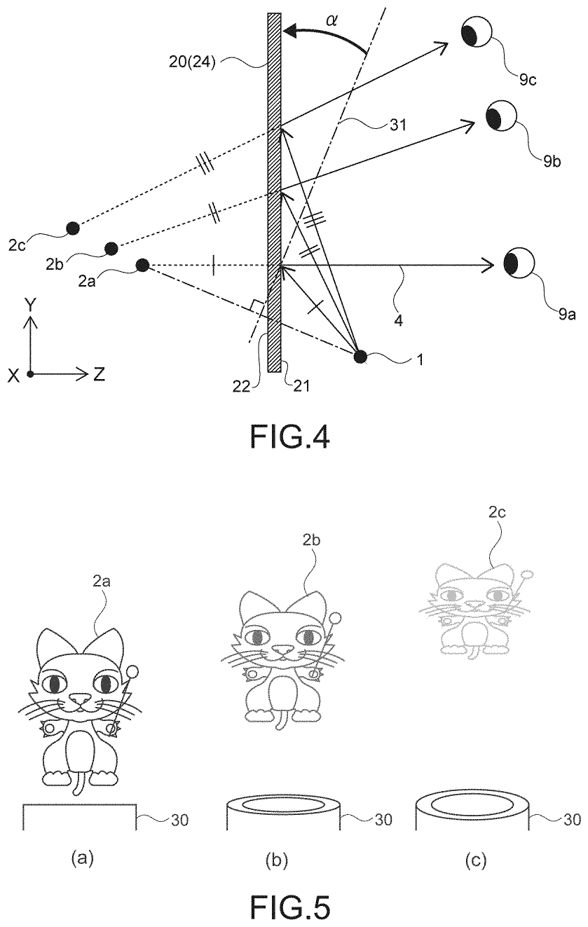

FIG. 4 is a schematic diagram used to describe a relationship between a position of a virtual image displayed by the virtual-image screen 20 and an observation direction. FIG. 5 schematically illustrates an example of the virtual image 2 displayed by the virtual-image screen 20. General properties of the virtual-image screen 20 are described below using the reflective hologram 24. Note that a change in virtual image and a change in a position of the virtual image are highlighted in FIGS. 4 and 5.

A position of a point of view 9 is moved when a face of the user 3 observing the image display apparatus 100 is moved. At this point, there is a change in an observation direction (a line-of sight direction) in which the user 3 observes the virtual-image screen 20.

For example, when the face of the user 3 is moved upward or downward, there is a change in an elevation angle corresponding to the direction of observation of the virtual-image screen 20. Further, for example, when the face of the user 3 is moved rightward or leftward, there is a change in an azimuth angle corresponding to the direction of observation of the virtual-image screen 20.

Here, the elevation angle is, for example, an angle formed by a vector that represents a target direction (such as the observation direction) and the XZ plane (the horizontal plane). Further, the azimuth angle is, for example, an angle that indicates a direction of the vector in the XZ plane when the vector is projected onto the XZ plane.

FIG. 4 illustrates positions of virtual images 2a to 2c that are respectively displayed toward three points of view 9a to 9c for which respective elevation angles are different from each other. The virtual images 2a to 2c are the virtual images 2 used to display one object image 1 (one point on the object image 1).

Further, (a) to (c) of FIG. 5 schematically illustrate examples of the virtual images 2 respectively observed from the points of view 9a to 9c. Here, it is assumed that the virtual image 2 is displayed using, as a reference, a stage 30 that is an object in a real space.

The point of view 9a is a point of view from which the virtual-image screen 20 is observed in the Z direction (along the standard observation axis 4). For example, the virtual image 2a observed from the point of view 9a is an image parallel to the object image 1 and the virtual-image screen 20, and the position of the virtual image 2a is a design-related display position. For example, as illustrated in (a) of FIG. 5, the virtual image 2a of a character that is arranged above the stage 30 at a specified interval, is observed from the point of view 9a. The virtual image 2a is an image displayed in a design-related display pose at a design-related display position.

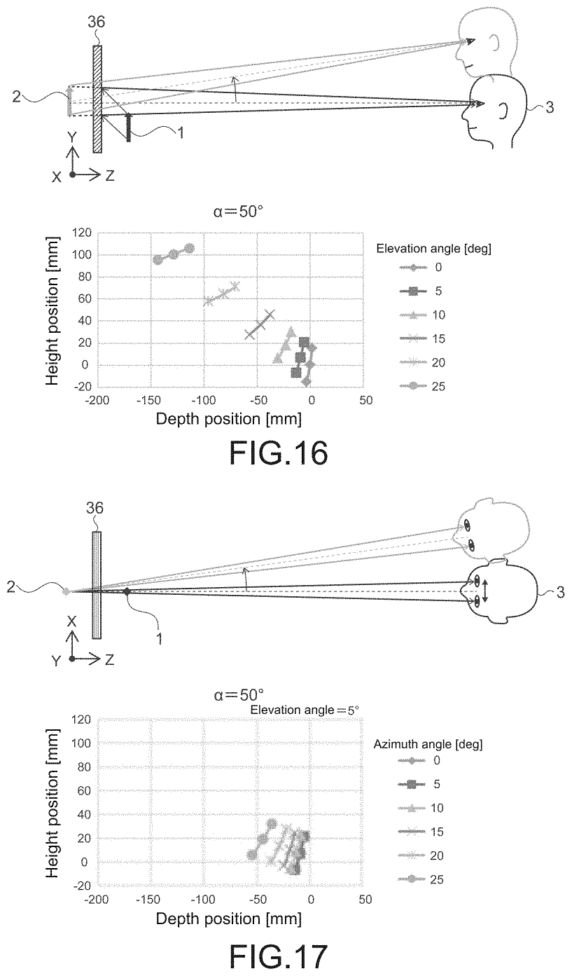

The point of view 9b is a point of view from which the virtual-image screen 20 is observed, the point of view 9b being situated at a position situated higher than the position of the point of view 9a. The point of view 9b exhibits a larger elevation angle corresponding to the observation direction than the point of view 9a. In this case, as illustrated in FIG. 4, the display position of the virtual image 2b is shifted upward and rearward (in a direction opposite to the user 3) from the display position as observed from the point of view 9a, as viewed from the user 3. Consequently, the virtual image 2b is moved further upward relative to the stage 30, and is smaller in size than the virtual image 2a, as illustrated in (b) of FIG. 5. Further, the virtual image 2b is inclined to fall toward the user 3, and thus there is a change in display pose (refer to FIG. 16). Consequently, the virtual image 2b becomes a distorted image, compared with the virtual image 2a.

The point of view 9c is a point of view from which the virtual-image screen 20 is observed, the point of view 9c being situated at a position situated higher than the position of the point of view 9b. The point of view 9c exhibits a larger elevation angle corresponding to the observation direction than the point of view 9b. In this case, the display position of the virtual image 2c is shifted upward and rearward from the display position as observed from the point of view 9b. Consequently, the virtual image 2c is displayed further upward than the virtual image 2b. The virtual image 2c is smaller in size than the virtual image 2b, and becomes a largely distorted image, compared with the virtual image 2b.

Further, when the virtual-image screen 20 is observed at an angle different from an angle corresponding to the standard observation axis 4, as observed from the point of view 9b or 9c, there is a reduction in the display brightness of the virtual image 2 due to a reduction in the diffraction efficiency of the reflective hologram 24. In the example illustrated in FIG. 5, the virtual image 2a is a brightest image, and the virtual image 2c is a darkest image.

Note that there is also a change in, for example, the display position, the display pose, and the display brightness of the virtual image 2 when there is a change in an azimuth angle corresponding to the observation direction due to the user 3 moving his/her face rightward or leftward (for example, refer to FIG. 17).

As described above, the virtual image 2 is moved when the user 3 moves his/her face in an elevation direction (an up-and-down direction) or an azimuth direction (a left-and-right direction), and this may result in a sense of reality with respect to the virtual image 2 being reduced. For example, there is a change in virtual image that is caused due to one user 3 moving his/her face, and this may result in difficulty in causing the user to perceive as if the virtual image 2 was localized in a real space. Further, when the virtual image 2 is displayed to a plurality of users 3, the virtual image 2 may be visible by each user 3 at a different position, or it may be difficult to see the virtual image 2 by the virtual image 2 falling. Furthermore, the observation direction may be outside of an angular range in which display can be performed by the virtual-image screen 20, and this may result in a virtual image not being displayed.

Here, the inventors have discussed the virtual image 2 displayed using the reflective hologram 24. Then, they have found out conditions related to the interference fringes 8 of the reflective hologram 24 such that there is only a small change in, for example, the display position of the virtual image 2 due to a change in observation direction. This is specifically described below.

[Setting of Boundary Pitch]

In the present embodiment, the boundary pitch Λ of the interference fringes 8 is set such that an intersection angle α formed by the reflective hologram 24 and a bisector 31 of a line that connects the object image 1 and the virtual image 2 displayed to be oriented toward the exit direction is less than or equal to 16.3 degrees.

As described with reference to FIG. 2, the flat-mirror reflective hologram 24 having no refractive power is used in the present embodiment. In this case, the position P of the object image 1, the incident position Q of the image light 5, and the virtual-image position P′ form an isosceles triangle, and the bisector 31 of the line PP′ is a line that passes through the incident position Q. An angle formed by the bisector 31 and the third surface 21 is the intersection angle α.

For example, when Formula (1) described above is modified on the basis of an angular relationship in isosceles triangle illustrated in FIG. 2, the boundary pitch Λ can be represented using the wavelength λ, the exit angle θₒᵤₜ (or the angle of incidence θₒᵤₜ), and the intersection angle α. Thus, for example, when the wavelength λ and exit angle θₒᵤₜ, which are to be used, are set, the boundary pitch Λ can be determined by setting the intersection angle α.

Further, a pair of the angle of incidence θᵢₙ and the exit angle θₒᵤₜ (a pair of an incident direction and an exit direction) that satisfies the angular relationship described above can be selected discretionarily for α having a certain value. From among them, the angle of incidence θᵢₙ and the exit angle θₒᵤₜ are set in a range in which, for example, the object image 1 and the virtual image 2 do not overlap.

With respect to the exit angle θₒᵤₜ (the angle of incidence θᵢₙ) set described above, the boundary pitch Λ is set such that the intersection angle α satisfies 0 degrees<α≤16.3 degrees.

When the boundary pitch Λ is set on the basis of the intersection angle α, this makes it possible to make a change in virtual image due to the movement of a face small, as illustrated in a graph described below.

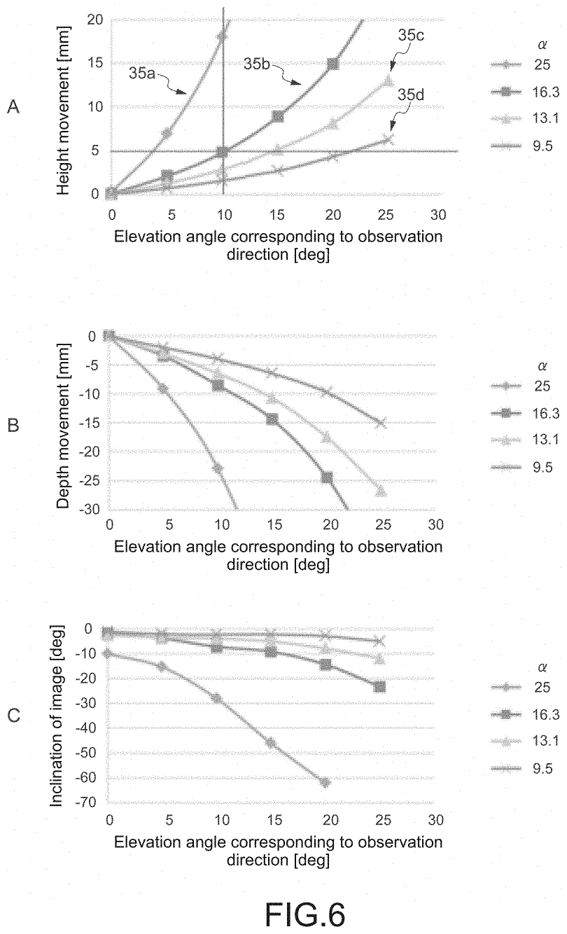

FIG. 6 is a set of graphs illustrating a change in the virtual image 2 depending on an elevation angle corresponding to an observation direction.

Graphs of a simulation result are given in FIG. 6, where the simulation result is obtained by calculating an amount of height movement of the virtual image 2 (A of FIG. 6), an amount of depth movement of the virtual image 2 (B of FIG. 6), and an amount of a change in inclination of the virtual image 2 (C of FIG. 6) while changing an elevation angle corresponding to an observation direction (a point-of-view elevation angle). A horizontal axis of each graph represents the elevation angle corresponding to an observation direction, with the horizontal direction being 0 degrees. Further, a vertical axis of each graph is set on the basis of a state of the virtual image 2 observed from the horizontal direction.

Further, data 35a to data 35d when respective intersection angles α are set to 25 degrees, 16.3 degrees, 13.1 degrees, and 9.5 degrees are plotted on each of the graphs of A to C of FIG. 6. From among the pieces of data, the data 35b, the data 35c, and the data 35d are pieces of data for the reflective hologram 24 for which the boundary pitch Λ such that the intersection angle α is less than or equal to 16.3 degrees is set.

When the intersection angle α=25 degrees (the data 35a), an amount of a vertical movement of the virtual image 2 is sharply increased with a change in the elevation angle α t the time of observation, as illustrated in A of FIG. 6. Consequently, when α=25 degrees, there is a height movement of about 18 mm at the timing at which the elevation angle corresponding to an observation direction is reached to 10 degrees. In other words, just due to an elevation angle when the user 3 views the virtual-image screen 20 being changed by 10 degrees, the position of the virtual image 2 is changed by the virtual image 2 being displaced upward by 18 mm. Further, when α=25 degrees, an amount of movement in a depth direction is greater than or equal to −20 mm, and the image is inclined at an angle close to −30 degrees, with the elevation angle corresponding to the observation direction being 10 degrees, as illustrated in B and C of FIG. 6. The above-described configuration in which the boundary pitch Λ such that α=25 degrees is set may result in a sense of reality being significantly reduced due to the virtual image 2 being moved or inclined.

On the other hand, when the intersection angle α=16.3 degrees (the data 35b), a change in virtual image is made sufficiently small. For example, when α=16.3 degrees, a height movement of the virtual image 2 is reduced up to about 5 mm, with the elevation angle corresponding to the observation direction being 10 degrees, as illustrated in A of FIG. 6. Further, when α=13.1 degrees and when α=9.5 degrees (the data 35c and the data 25d), the height movement of the virtual image 2 is made smaller.

Further, when α is less than or equal to 16.3 degrees, the amount of movement in the depth direction is less than or equal to −10 mm, and the image is inclined at an angle less than or equal to −10 degrees, as illustrated in B and C of FIG. 6.

The above-described configuration in which the boundary pitch Λ such that α≤16.3 degrees is set results in sufficiently preventing the virtual image 2 from being moved and inclined due to a change in an elevation angle corresponding to an observation direction. In this case, even when, for example, the observation direction is changed in a certain range of elevation angle (such as a range of from 0 degrees to 10 degrees), the position and the pose of the virtual image 2 are hardly changed. This makes it possible to perform display with a sense of reality to provide the feeling that the virtual image 2 actually exists there.

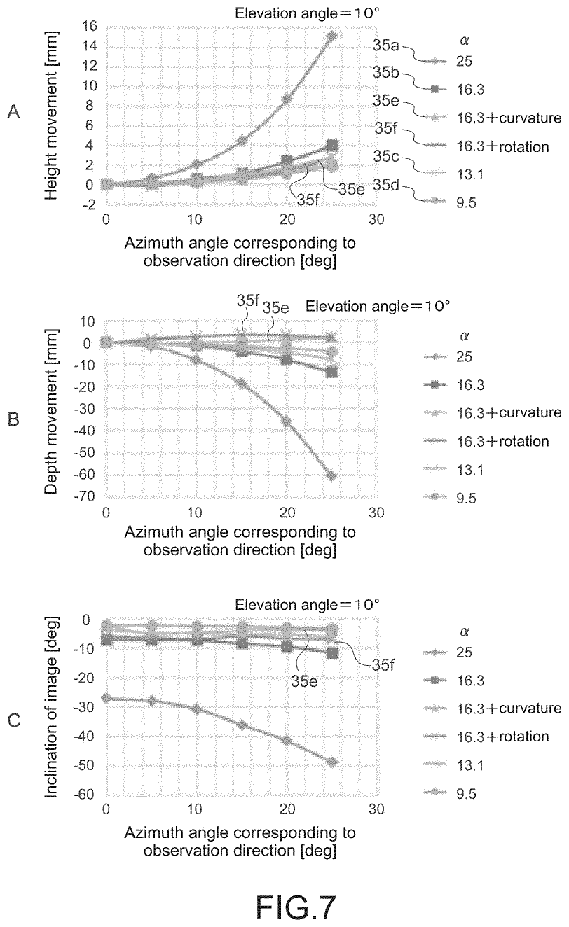

FIG. 7 is a set of graphs illustrating a change in the virtual image 2 depending on an azimuth angle corresponding to an observation direction.

Graphs of a simulation result are given in FIG. 7, where the simulation result is obtained by calculating an amount of height movement of the virtual image 2 (A of FIG. 7), an amount of depth movement of the virtual image 2 (B of FIG. 7), and an amount of a change in inclination of the virtual image 2 (C of FIG. 7) while changing an azimuth angle corresponding to an observation direction (a point-of-view azimuth angle). In each graph illustrated in FIG. 7, the elevation angle corresponding to the observation direction is set to 10 degrees.

A horizontal axis of each graph represents the azimuth angle corresponding to an observation direction, with a direction (the Z direction) orthogonal to the virtual-image screen 20 being 0 degrees. Further, a vertical axis of each graph is set on the basis of a state of the virtual image 2 observed when the elevation angle is 10 degrees and the azimuth angle is 0 degrees.

Further, the data 35a to the data 25d when the respective intersection angles α are set to 25 degrees, 16.3 degrees, 13.1 degrees, and 9.5 degrees are plotted on each of the graphs of A to C of FIG. 7. From among the pieces of data, the data 35b, the data 35c, and the data 35d are pieces of data for the reflective hologram 24 for which the boundary pitch Λ such that the intersection angle α is less than or equal to 16.3 degrees is set.

Note that data 35e is data when the intersection angle α=16.3 degrees, and is data for a reflective hologram that is curved such that a convex side of the reflective hologram faces a user. Data 35f is data when the intersection angle α=16.3 degrees, and is data for a reflective hologram in which a direction of a period of interference fringes is rotated about an axis in the Z direction. The data 35e and the data 35f will be described later.

As illustrated in A of FIG. 7, the height movement of the virtual image 2 exhibits a largest value when the intersection angle α=25 degrees (the data 35a). For example, there is a height movement of 8 mm or more upon observation at an azimuth angle of 20 degrees.

When the intersection angle α≤16.3 degrees (the data 35b, the data 35c, and the data 35d), the height movement due to a change in azimuth angle is sufficiently suppressed. For example, there is a height movement of 3 mm or less upon observation at an azimuth angle of 20 degrees.

As illustrated in B of FIG. 7, the depth movement of the virtual image 2 also exhibits a largest value when the intersection angle α=25 degrees, and, for example, there is a depth movement of −30 mm or more upon observation at an azimuth angle of 20 degrees.

When the intersection angle α≤16.3 degrees, the depth movement due to a change in azimuth angle is also sufficiently suppressed, and, for example, there is a depth movement of −10 mm or less upon observation at an azimuth angle of 20 degrees.

As illustrated in C of FIG. 7, when the intersection angle α=25 degrees, the virtual image 2 is inclined at an angle close to −30 degrees at the timing at which the azimuth angle is 0 degrees, as viewed from an observation direction corresponding to an elevation angle of 10 degrees.

When the intersection angle α≤16.3 degrees, the virtual image 2 is inclined at an angle less than or equal to −10 degrees. Further, in this case, an angle of inclination of the virtual image 2 is hardly changed in spite of a change in azimuth angle.

The above-described configuration in which the boundary pitch Λ such that α≤16.3 degrees is set results in sufficiently preventing the virtual image 2 from being moved and inclined due to a change in an azimuth angle corresponding to an observation direction.

Consequently, the position and the pose of the virtual image 2 are hardly changed even when, for example, the user 3 moves rightward or leftward. This makes it possible to perform display with a sense of reality.

[Setting of Slant Angle]

An angular range (a display angular range) used to display the virtual image 2 is set for the image display apparatus 100. The display angular range refers to angular ranges of an elevation angle and an azimuth angle in which the virtual image 2 can be properly displayed. For example, the image display apparatus 100 is configured such that a height position, a depth position, an image inclination, and the like of the virtual image 2 observed from an observation direction within the display angular range are within a specified acceptable range.

The display angular range is set on the basis of the characteristics of a change in a position and a pose of a virtual image that is caused depending on an observation direction, as described with reference to, for example, FIGS. 6 and 7. Alternatively, on the basis of, for example, the efficiency of diffraction of the image light 5 that is performed by the reflective hologram 24, the display angular range is set to be a diffraction-efficiency angular range in which the diffraction efficiency exhibiting a value greater than or equal to a certain value is obtained. Alternatively, the display angular range may be set according to, for example, the application of the image display apparatus 100.

In the present embodiment, the slant angle φ of the interference fringe 8 of the reflective hologram 24 is set such that the diffraction efficiency in a range of elevation angle (a display elevation range) set to be the display angular range exhibits a desired distribution.

In the reflective hologram 24, the Bragg condition is satisfied and the efficiency in diffracting the image light 5 is maximal when the image light 5 incident from an incident direction (at the angle of incidence θᵢₙ) is diffracted in an exit direction (at the exit angle θₒᵤₜ). In other words, it can be said that the exit angle θₒᵤₜ is the Bragg angle.

The slant angle φ can be represented as, for example, a function of θᵢₙ and θₒᵤₜ using the Bragg condition. Thus, when, for example, the incident direction (a direction of projection of the image light 5) is set, the exit direction (exit angle θₒᵤₜ) can be determined by setting the slant angle φ.

Thus, a direction in which the diffraction efficiency is maximal is determined by setting the slant angle φ, as described above, and an angular distribution of a diffraction efficiency in a display elevation range can be set.

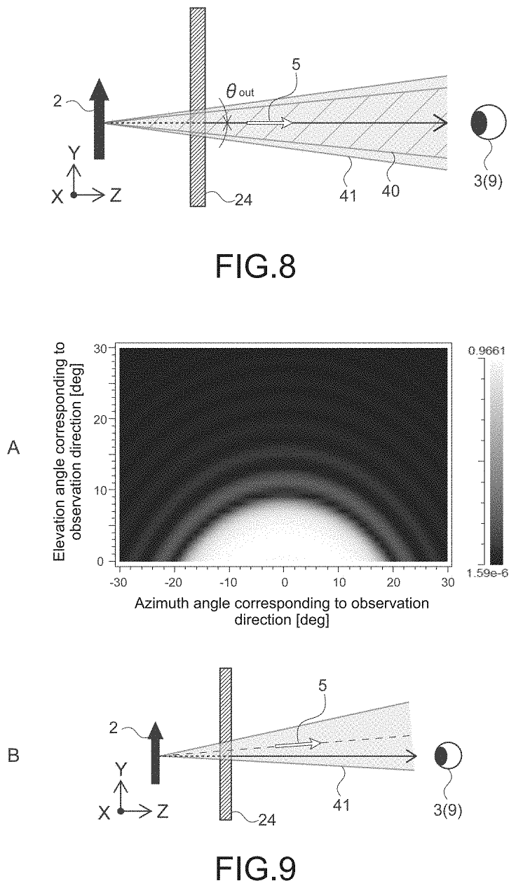

FIG. 8 is a schematic diagram used to describe a relationship between a display elevation range and the exit angle θₒᵤₜ. FIG. 8 schematically illustrates a display elevation range 40 (a hatched range) that is set for the image display apparatus 100, and a diffraction-efficiency elevation range 41 (a gray range) of the reflective hologram 24.

Here, the diffraction-efficiency elevation range 41 is, for example, a range of an exit elevation angle in which the image light 5 can be diffracted with the diffraction efficiency that enables the virtual image 2 to be displayed (a diffraction efficiency exhibiting a value greater than or equal to 30% of a value of a diffraction-efficiency peak). Further, the diffraction efficiency in the diffraction-efficiency elevation range 41 reaches a peak at the exit angle θₒᵤₜ.

For example, the slant angle φ is set so that the exit angle θₒᵤₜ is within the display elevation range 40. In this case, the image light 5 exiting at an elevation angle within the display elevation range 40 includes the image light 5 diffracted under an on-Bragg condition and the image light 5 diffracted under an off-Bragg condition.

The on-Bragg condition is a condition for an angle of incidence and an exit angle of the image light 5 that satisfy the Bragg condition. The image light 5 diffracted under the on-Bragg condition is the image light 5 being incident on the reflective hologram 24 at the angle of incidence θᵢₙ and exiting the reflective hologram 24 at the exit angle θₒᵤₜ. In this case, the efficiency in diffracting the image light 5 is maximal.

The off-Bragg condition is, for example, a condition for the angle of incidence and the exit angle in which the Bragg condition is intendedly not adopted. Here, diffraction of the image light 5 in which the diffraction efficiency exhibits a value greater than or equal to a first threshold and the diffraction efficiency is not maximal, is defined as diffraction performed under the off-Bragg condition. The first threshold is, for example, a value greater than or equal to 50% of a diffraction-efficiency peak. Without being limited thereto, the first threshold can be set as appropriate. In the present embodiment, the first threshold corresponds to a first value.

As described above, the slant angle φ of the interference fringe 8 is set to be an angle in which the image light 5 diffracted under the Bragg condition is within the display elevation range used to display the virtual image 2. In other words, the slant angle φ is set to be an angle in which the efficiency in diffracting the image light 5 diffracted in the display elevation range, exhibits a value greater than or equal to the first threshold.

This makes it possible to diffract the image light 5 within the display elevation range with an efficiency that exhibits a value greater than or equal to the first threshold and includes a maximal diffraction efficiency, and thus to display a bright virtual image 2. This results in being able to improve the visibility of the virtual image 2.

In the example illustrated in FIG. 8, the display elevation range 40 is set to be a range of elevation angle that has a shape symmetric about a line parallel with the horizontal direction. Further, the slant angle φ is set such that the exit angle θₒᵤₜ (the Bragg angle) corresponds to the center (an elevation angle of 0 degrees) of the display elevation range 40. Note that, in FIG. 8, the display elevation range 40 is set such that the angular width is within the diffraction-efficiency elevation range 41.

In this case, the image light 5 diffracted under the on-Bragg condition exits in the horizontal direction. Thus, the virtual image 2 is most brightly displayed when the reflective hologram 24 is observed from the horizontal direction. Further, the image light 5 diffracted under the off-Bragg condition exits in a direction that deviates upward or downward from the horizontal direction. This makes it possible to display the virtual image 2 with a sufficient brightness even when a point of view of the user 3 is moved downward or diagonally upward, with a line in parallel with the horizontal direction being used as a reference.

Note that the slant angle φ does not necessarily have to be set such that the Bragg angle corresponds to the center of the display elevation range 40 to be used, and may be set as appropriate such that desired display of a virtual image can be performed.

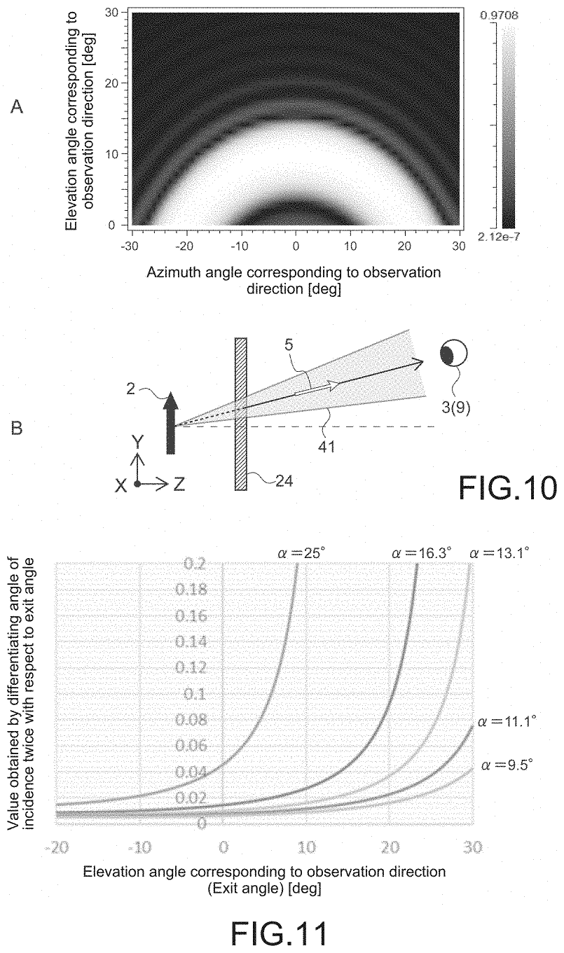

FIGS. 9 and 10 illustrate examples of the diffraction-efficiency elevation range 41 depending on the slant angle φ. A of FIG. 9 and A of FIG. 10 are maps of examples of angular distributions of a diffraction efficiency of the reflective hologram 24. A vertical axis of each map represents an elevation angle corresponding to an exit direction of the image light 5 exiting the reflective hologram A, and a horizontal axis of each map represents an azimuth angle corresponding to the exit direction. Further, a color of each point represents the diffraction efficiency depending on the elevation angle and azimuth angle corresponding to the exit direction.

B of FIG. 9 and B of FIG. 10 each schematically illustrate the diffraction-efficiency elevation range 41 of the reflective hologram 24 of a corresponding one of A of FIG. 9 and A of FIG. 10.

In A of FIG. 9, the slant angle φ is set such that the exit angle θₒᵤₜ is an angle situated at a position higher than an angle corresponding to the horizontal direction in an angular range in which the angle corresponding to the horizontal direction (an elevation angle of 0 degrees) is within the diffraction-efficiency elevation range 41. In this case, an elevation range in which a diffractive efficiency of a certain level is obtained can be displaced upward from the horizontal direction, as illustrated in B of FIG. 9. For example, it can be said that this configuration is a configuration in which the Bragg angle is shifted upward from the configuration illustrated in FIG. 8.

For example, when, for example, a point of view of the user 3 is assumed to be moved upward upon observing the image display apparatus 100, the configuration in which the diffractive efficient elevation range 41 is inclined diagonally upward is adopted, as illustrated in FIG. 9. This makes it possible to display a bright virtual image 2 even when the point of view is largely moved.

In A of FIG. 10, the slant angle φ is set such that the exit angle θₒᵤₜ is an angle situated at a position higher than an angle corresponding to the horizontal direction in an angular range in which the angle corresponding to the horizontal direction is outside of the diffraction-efficiency elevation range 41. In this case, a bright virtual image 2 is displayed to the point of view of the user observing the reflective hologram 24 from diagonally above, as illustrated in B of FIG. 10. Further, the bright virtual image 2 is not visually recognized when the reflective hologram 24 is observed from the horizontal direction.

For example, when the image display apparatus 100 is arranged further downward than the point of view of the user 3 and the observation direction is a direction substantially diagonally upward, as viewed from the image display apparatus 100, the configuration illustrated in FIG. 10 is adopted.

Further, for example, the slant angle φ may be set such that the exit angle θₒᵤₜ is outside of the display elevation range 40. In other words, setting can be performed such that the Bragg angle is outside of the display elevation range. In this case, the image light 5 exiting at an elevation angle in the display elevation range 40 only includes the image light 5 diffracted under the off-Bragg condition.

Thus, the diffraction efficiency in the display elevation range 40 exhibits a value greater than or equal to the first threshold and less than or equal to a second threshold. For example, the second threshold may be set as appropriate in a range in which the virtual image 2 can be properly displayed. In the present embodiment, the second threshold corresponds to a second value.

As described above, the slant angle φ of the interference fringe 8 may be set to be an angle in which only the image light 5 diffracted under a condition (the off-Bragg condition) in which the Bragg condition is intendedly not adopted, is within the display elevation range 40. In other words, the slant angle φ may be set to be an angle in which the efficiency in diffracting the image light 5 diffracted in a range of elevation angle (the display elevation range 40) that is set to be the display angular range used to display the virtual image 2, exhibits a value greater than or equal to the first threshold and less than or equal to the second threshold.

In this case, the virtual image 2 can also be properly displayed in the display elevation range 40. For example, when the necessary display elevation range 40 is desired to be made smaller, the off-Bragg condition is adopted, as described above.

As described above, in the present embodiment, the slant angle φ for the reflective hologram 24 is set such that both the on-Bragg condition and the off-Bragg condition are included or only the off-Bragg condition is adopted. This makes it possible to set the diffraction efficiency high only in the display elevation range 40, and thus to display a bright virtual image 2. Further, it is possible to intendedly set the diffraction efficiency low in a range outside of the display elevation range 40 (that is, an elevation range that is not desired to be seen by the user 3), and to not cause the user to see a change in the virtual image 2. This results in preventing a change in virtual image from being visually recognized, and thus in being able to prevent a sense of reality with respect to the virtual image 2 from being reduced.

FIG. 11 is a graph illustrating an absolute value of a value obtained by differentiating the angle of incidence θᵢₙ twice with respect to the exit angle θₒᵤₜ. For example, the image light 5 incident on the reflective hologram 24 at the angle of incidence θᵢₙ (an incident elevation angle) is diffracted at the exit angle θₒᵤₜ (an elevation angle corresponding to an observation direction) corresponding to the angle of incidence θᵢₙ and the intersection angle α set for the reflective hologram 24. Each graph illustrated in FIG. 11 is obtained by plotting an absolute value of a value obtained by differentiating the angle of incidence θᵢₙ twice with respect to the exit angle θₒᵤₜ for each intersection angle α, and can be said to be a graph illustrating an amount of change in the angle of incidence θᵢₙ with respect to the exit angle θₒᵤₜ at each intersection angle α. The reflective hologram 24 may be designed on the basis of such a change in the angle of incidence θᵢₙ.

For example, design parameters of the reflective hologram 24 (the boundary pitch Λ and the slant angle φ) are set such that an absolute value of a value obtained by differentiating the angle of incidence θᵢₙ twice with respect to the exit angle θₒᵤₜ is less than or equal to a specified threshold in an elevation angle assumed to correspond to an observation direction (an exit angle θₒᵤₜ). For example, the reflective hologram 24 designed such that the value obtained by differentiating the angle of incidence θᵢₙ twice is less than or equal to about 0.03 in a range of an exit angle θₒᵤₜ of from 0 degrees to 10 degrees, exhibits the behavior equivalent to that of the reflective hologram 24 for which a is set to be less than or equal to 16.3 degrees, as illustrated in FIG. 11. This makes it possible to sufficiently suppress a change in virtual image due to a change in an elevation angle corresponding to an observation direction.

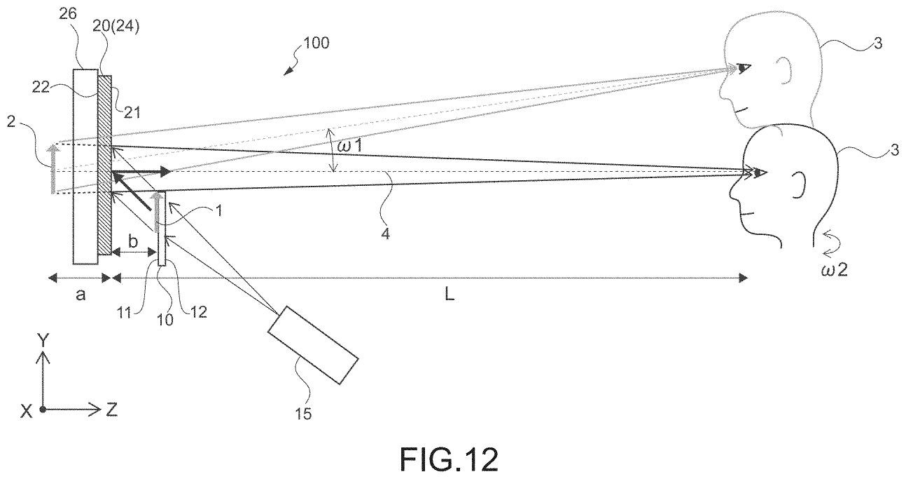

FIG. 12 schematically illustrates a specific example of the configuration of the image display apparatus 100. In the example illustrated in FIG. 12, a diffusion screen is used as the real-image screen 10. The image display apparatus 100 further includes a projector 15 that projects the image light 5 of the object image 1 onto the diffusing screen. In the present embodiment, the projector 15 corresponds to a projection section.

A design value of the image display apparatus 100 is described. Note that numerical values described below are merely examples, and each design value can be selected as appropriate.

A visual-recognition distance L is a distance from the third surface 21 of the virtual-image screen 20 to the point of view 9 of the user 3, and is set in a range of, for example, 200 mm≤L≤2000 mm.

An angular range ω1 of an elevation movement of the point of view 9 corresponds to the display elevation range described above. The image display apparatus 100 is configured to properly display the virtual image 2 relative to the display elevation range ω1. The display elevation range ω1 is set to be a range of, for example, 0 degrees≤ω1≤10 degrees.

An angular range ω2 of an azimuth movement of the point of view 9 corresponds to a range of azimuth angle set to be the display angular range described above (a display azimuth range). The image display apparatus 100 is configured to properly display the virtual image 2 relative to the display azimuth range ω2. The display elevation range ω2 is set to be a range of, for example, −15 degrees≤ω2≤15 degrees.

A virtual-image display distance a is a horizontal distance from the third surface 21 of the virtual-image screen 20 to a position at which the virtual image 2 is displayed, and setting is performed such that, for example, a=about 50 mm.

A screen-to-screen distance b is a horizontal distance between the third surface 21 of the virtual-image screen 20 and the first surface 11 of the real-image screen 10 (the object image 1), and setting is performed such that, for example, b=about 45 mm.

In the example illustrated in FIG. 12, the virtual-image screen 20 is formed using the reflective hologram 24 and a transparent base material 26. The reflective hologram 24 is attached to a side of the transparent base material 26 that faces the user 3. Note that, as described with reference to FIG. 2, the reflective hologram 24 may be attached to a side of the virtual image 2 that faces the transparent base material 26, or may be formed integrally with the transparent base material 26. Alternatively, a configuration in which the reflective hologram 24 is sandwiched between two transparent base materials 26 may be adopted.

For example, the boundary pitch Λ for the reflective hologram 24 is set to 1200 nm, and the slant angle φ for the reflective hologram 24 is set to 81.4 degrees. Here, the exit angle θₒᵤₜ is set to 0 degrees, and the Bragg condition is satisfied with respect to an observation direction in which the virtual-image screen 20 is observed in parallel with the Z direction, where on-Bragg is applied. FIG. 12 schematically illustrates, using black thick arrows, an incident direction and an exit direction that satisfy the Bragg condition. Further, with respect to an observation direction that intersects the Z direction, off-Bragg is applied.

The slant angle φ satisfying the Bragg condition can be freely selected relative to the display elevation range ω1 to be used. In any case, the face of the user 3 is moved, and thus, the image display apparatus 100 is used under both the on-Bragg condition and the off-Bragg condition, or under the off-Bragg condition.

At a specified angle of radiation (angle of view), the projector 15 emits the image light 5 making up a target image that corresponds to the object image 1. As illustrated in FIG. 12, the projector 15 is arranged to project the image light 5 at a specified angle of projection (in a projection direction). This angle of projection is a center angle of an angle of radiation. The above-described oblique projection of the image light 5 makes it possible to improve the brightness of the image light 5 exiting the real-image screen 10.

A laser projector or the like using a laser source (a laser diode, LD) is used as the projector 15. In the present embodiment, a scanning laser projector that scans laser light and projects an image using a scanning projector using microelectromechanical systems (MEMS) is used. Note that a projection laser projector using, for example, a liquid crystal light bulb may be used.

The use of a laser source makes it possible to project a target image using pieces of narrowband light of R, G, and B, and thus to narrow a band of the image light 5. This makes it possible to provide a great diffraction performance. Note that the projector 15 using, for example, an LED light source or a lamp light source may be used as a light source. In this case, the narrowband image light 5 can be projected by using, for example, a narrowband filter used to narrow a band of light in combination.

FIG. 13 schematically illustrate examples of configurations of the real-image screen 10. A of FIG. 13 schematically illustrates a real-image screen 10a that is a transmissive diffusion screen, and the projector 15 projecting the image light 5 onto the corresponding screen, and B of FIG. 13 schematically illustrates a real-image screen 10b that is a reflective diffusion screen, and the projector 15 projecting the image light 5 onto the corresponding screen.

As illustrated in A of FIG. 13, the real-image screen 10a includes a first surface 11a and a second surface 12a. Light incident on the second surface 12a is transmitted through the real-image screen 10a, and is diffused by the real-image screen 10a to exit the first surface 11a situated opposite to the second surface 12a.

Thus, the second surface 12a serves as a projection surface onto which the image light 5 of the object image 1 is projected by the projector 15. Further, the first surface 11a serves as a diffusion surface on which the image light 5 is diffused to exit the diffusion surface. Accordingly, the object image 1 that is a target image made up of the image light 5 emitted by the projector 15 is formed on the first surface 11a.

A of FIG. 13 schematically illustrates the object image 1 formed on the real-image screen 10a (the first surface 11a), and the image light 5 (diffused light) making up the object image 1. Note that the transmissive real-image screen 10a is used in the configuration illustrated in FIG. 12.

For example, the use of the transmissive real-image screen 10a makes it possible to improve a degree of freedom in arrangement of the projector 15, and thus to accept various projection angles and projection distances.

As illustrated in B of FIG. 13, the real-image screen 10b includes a first surface 11b and a second surface 12b. Light incident on the first surface 11b is reflected off the real-image screen 10b, and is diffused by the real-image screen 10b to exit the first surface 11b.

Thus, the first surface 11b is a projection surface onto which the image light 5 of the object image 1 is projected by the projector 15, and serves as a diffusion surface on which the image light 5 is diffused to exit the diffusion surface. Accordingly, the object image 1 that is a target image made up of the image light 5 emitted by the projector 15 is formed on the first surface 11a.

For example, the use of the reflective real-image screen 10b makes it possible to arrange the projector 15 further inward than the real-image screen 10 in the apparatus, and thus to make the apparatus smaller in size.

For example, a transmissive HOE or a reflective HOE that has diffusion properties is used as the diffusion screen (the real-image screens 10a and 10b). Alternatively, a screen other than the HOE having diffusion properties may be used. Further, for example, an anisotropic diffusion screen configured to cause diffused light to exit in a specified projection direction may be used. Moreover, a specific configuration of the diffusion screen is not limited.

FIG. 14 schematically illustrates another example of the configuration of the real-image screen 10. A real-image screen 10c illustrated in FIG. 14 is a display that is capable of displaying thereon the object image 1. In the present disclosure, the display is a display apparatus that displays a target image (the object image 1) on a display surface without projecting the image light 5.

A display, such as an organic EL display or a plasma display, that includes a self-luminous panel that emits light for each pixel to display an image is used as the real-image screen 10c. Alternatively, a display, such as a liquid crystal display, that includes a backlight panel that modulates light for each pixel to display an image may be used.

As illustrated in FIG. 14, the real-image screen 10c includes a first surface 11c. The first surface 11c serves as a display surface that displays thereon the object image 1, and diffused light (the image light 5) with which each pixel of the object image 1 exits from each point of the first surface 11c.

No matter which of the displays is used, the object image 1 can be projected in a specified projection direction by controlling a direction in which light exits (a projection direction) and an angle of diffusion of the light.

In the case of the above-described real-image screen 10c using a display that includes a self-luminous panel or a backlight panel, there is no need for a projection optical system (a projection system) used to project the image light 5.

This makes it possible to prevent the apparatus from being made larger in size, and thus to obtain a compact image display apparatus 100.

FIG. 15 schematically illustrates examples of arrangements of the real-image screen. The example in which the real-image screen 10 is arranged diagonally below the third surface 21 of the virtual-image screen 20, as illustrated in A of FIG. 15, has been described above. In this configuration, a see-through surface on which the virtual image 2 is displayed in a state of being superimposed on a background can be provided to an upper portion of the image display apparatus 100 (the virtual-image screen 20). This makes it possible to easily obtain the image display apparatus 100 used by being placed on, for example, a desk or a surface of a floor.

In the image display apparatus 100 illustrated in B of FIG. 15, the real-image screen 10 is arranged diagonally above the virtual-image screen 20. Specifically, the real-image screen 10 is arranged diagonally above a region on the third surface 21, the region being a region onto which the image light 5 of the object image 1 is projected. In this case, the virtual image 2 can be displayed in a desired direction by, for example, appropriately setting respective parameters (such as a boundary pitch and a slant angle) of the reflective hologram 24 corresponding to the virtual-image screen 20 according to, for example, a direction of projection of the object image 1 that is performed by the real-image screen 10.

The above-described configuration in which the see-through surface is provided to a lower portion of the image display apparatus 100 (the virtual-image screen 20) may be adopted in consideration of, for example, design and an angular range to be used (such as the display elevation range). This makes it possible to easily obtain the image display apparatus 100 used to be installed on, for example, a ceiling.

As described above, in the image display apparatus according to the present embodiment, the object image 1 formed on the first surface 11 of the real-image screen 10 is obliquely projected. The virtual-image screen 20 diffracts the image light 5 of the object image 1 incident on the third surface 21 parallel to the first surface 11 to form the virtual image 2 parallel to the object image 1. Here, the image light 5 is diffracted in an exit direction different from a specular-reflection direction that corresponds to an incident direction. Consequently, the virtual image 2 displayed in parallel with the virtual-image screen 20 can be observed from a direction that is different from a direction in which the image light 5 is specularly reflected. Accordingly, it is possible to make the apparatus smaller in size, and to perform display of a virtual image with a sense of reality.

A configuration in which image light of an object image exits in a specular-reflection direction may be adopted in order to display a virtual image. For example, it is assumed that a virtual image is displayed in a specular-reflection direction using a vertically arranged virtual-image screen. In this case, it is necessary that the image light be incident from the horizontal direction, in order to display the virtual image in the horizontal direction. This results in the virtual image and the object image overlapping. Further, there is a need to incline an observation direction in order for light to be obliquely incident on the screen, since there are constraints due to specular reflection (angle of incidence=exit angle). Consequently, the screen is inclined with respect to the line of sight, and this may result in making an observer feel uncomfortable with display of the virtual image.

Further, for example, a configuration in which a position at which a virtual image is observed by an observer is fixed, may be adopted. In this case, the screen may be arranged such that the observer can easily see the screen, but it is difficult to perform observation while moving. Further, in a configuration in which an observer looks down at a virtual image, there may be a reduction in the level of a form factor and the apparatus may be made larger in size, if the screen is inclined according to the orientation of the line of sight.

Further, when a configuration in which the observation position can be moved is adopted, the position of a virtual image may be largely shifted depending on the configuration of a hologram, and this may result in a reduction in a sense of reality.

FIGS. 16 and 17 each illustrate a change in virtual image on a hologram screen of a comparative example. Graphs that each represent a position of the virtual image 2 displayed by a reflective hologram screen 36 for which the boundary pitch Λ such that the intersection angle α=25 degrees is set, are given in FIGS. 16 and 13. The graph of FIG. 16 is a graph illustrating a movement of the virtual image 2 when there is a change in an elevation angle corresponding to an observation direction. The graph of FIG. 17 is a graph illustrating the movement of the virtual image 2 when there is a change in an azimuth angle corresponding to the observation direction. Note that, in FIG. 17, the azimuth angle is changed with an elevation angle of 5 degrees. A horizontal axis and a vertical axis of each graph are a depth position and a height position of the virtual image 2, respectively.

In the case of the hologram screen 36, the virtual image 2 is moved about 100 mm in the height direction and moved 100 mm or more in the depth direction when the elevation angle corresponding to the observation direction is changed from 0 degrees to 25 degrees, as illustrated in FIG. 16. Further, the virtual image 2 is inclined toward the user 3 so that the state of the virtual image 2 is changed to a nearly horizontal state from a vertical state. Further, when the azimuth angle corresponding to the observation direction is changed from 0 degrees to 25 degrees, the virtual image 2 is moved about 20 mm in the height direction, is moved about −50 mm in the depth direction, and is inclined toward the user 3, as illustrated in FIG. 17.

In the present embodiment, the image light 5 of the object image 1 obliquely projected by the real-image screen 10 in a projection direction exits the virtual-image screen 20 in a direction different from a specular-reflection direction of the projection direction to form an image parallel to the object image 1. Thus, no constraints due to specular reflection are imposed on a direction of diffraction of the image light that is performed by the virtual-image screen 20. This makes it possible to easily obtain a configuration in which the virtual image 2 and the object image 1 do not overlap even when, for example, the virtual image 2 is displayed in the horizontal direction.

Further, the object image 1 (the real-image screen 10), the virtual-image screen 20, and the virtual image 2 are arranged parallel to each other (arranged upright). This results in there being no need to arrange, for example, a screen at an angle, and thus in being able to improve a form factor of the image display apparatus 100. This makes it possible to make the apparatus smaller in size.

Further, the image display apparatus 100 is configured such that the virtual image 2 can be displayed to a certain display angular range. This enables observation with movement, that is, this enables the user 3 to observe the virtual image 2 while moving.

Further, in the image display apparatus 100, the angle of incidence θᵢₙ and the exit angle θₒᵤₜ (a diffraction angle) of the image light are set such that θᵢₙ≠θₒᵤₜ and the intersection angle α formed by the virtual-image screen 20 (the third surface 21) and a bisector of a line that connects the object image 1 and the virtual image 2, is set such that α≤16.3 degrees. This results in suppressing a change in virtual image due to movements of an observation direction and a visual-recognition position, and results in improving a sense of reality with respect to display of a virtual image.

As described above, in the image display apparatus 100, a virtual image is hardly moved due to the movement of a face even when the virtual-image screen 20 is vertically arranged in consideration of, for example, form factor. Consequently, a sense of reality with respect to the virtual image 2 is less likely to be reduced. Further, the visual-recognition position for observing the virtual image 2 is not fixed. Thus, it can be said that the image display apparatus 100 is an apparatus that enables a plurality of users 3 to simultaneously see the virtual image 2 situated at the same position. This makes possible to cause a plurality of users 3 to share the same viewing experience, and thus to provide a high quality of amusement.

### Second Embodiment

An image display apparatus according to a second embodiment of the present technology is described. In the following description, descriptions of a configuration and an operation similar to those of the image display apparatus 100 described in the embodiment above are omitted or simplified.

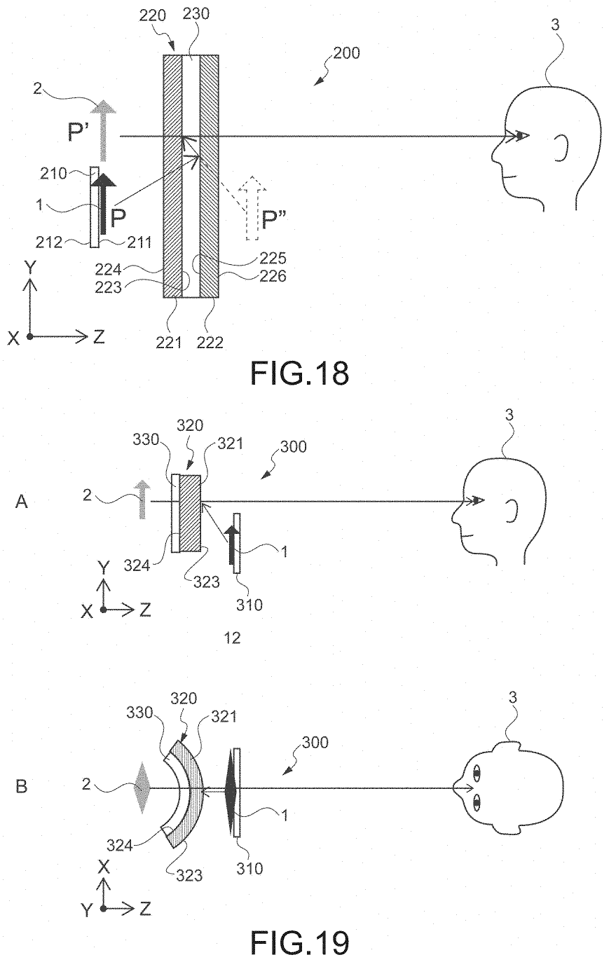

FIG. 18 schematically illustrates an example of a configuration of the image display apparatus according to the second embodiment. As illustrated in FIG. 18, an image display apparatus 200 includes a real-image screen 210 and a virtual-image screen 220 that are arranged parallel to each other. In the present embodiment, a virtual-image screen 220 that is transmissive in totality is formed using two reflective holograms of boundary pitches different from each other.

The real-image screen 210 includes a first surface 211 on which the object image 1 is formed, and a second surface 212 that is situated opposite to the first surface 211. The real-image screen 210 is in the form of a flat plate, and is arranged such that the first surface 211 faces the user 3 and the real-image screen 210 does not overlap the virtual image 2. Further, the real-image screen 210 is arranged across the virtual-image screen 220 from the user 3.

The virtual-image screen 220 includes a first reflective hologram 221, a second reflective hologram 222, and a transparent base material 230. The first and second reflective holograms 222 and 223 are respectively arranged on two surfaces of the transparent base material 230 in the form of a flat plate. The first reflective hologram 221 is arranged on the surface being included in the transparent base material 230 and facing opposite to the user 3, and the second reflective hologram 222 is arranged on the surface being included in the transparent base material 230 and facing the user 3. For example, a glass base or a base of plastics such as acrylic is used as the transparent base material 230. Note that, when, for example, the respective holograms are sufficiently rigid, the respective holograms may be arranged across an airspace from each other without using the transparent base material 230.

The first reflective hologram 221 includes a third surface 223 and a fourth surface 224 that is situated opposite to the third surface 223. The third surface 223 is a surface that faces the second reflective hologram 222 (a fifth surface 225), and the fourth surface 224 is a surface that faces the real-image screen 210.

The first reflective hologram 221 diffracts the image light 5 of the object image 1, and causes the image light 5 to exit in an exit direction. More specifically, the first reflective hologram 221 diffracts light incident on the first surface 211 at a specified angle through the transparent base material 230, and causes the light to exit the first surface 211. Note that the specified angle is, for example, an angle of incidence through a transparent medium (the transparent base material 230). In the present embodiment, the first reflective hologram 221 corresponds to a diffractive optical element.

The second reflective hologram 222 includes a fifth surface 225 and a sixth surface 226 that is situated opposite the fifth surface 225. The fifth surface 225 is a surface that faces the first reflective hologram 221 (the first surface 211), and the sixth surface 226 is a surface that faces the user 3. As described above, in the present embodiment, the second reflective hologram 222 is arranged across the first reflective hologram 221 from the real-image screen 210.

The second reflective hologram 222 diffracts the image light 5 passing through the first reflective hologram 221, and causes the image light 5 to exit the second reflective hologram 222 to be headed for the first reflective hologram 221. Further, interference fringes (a grating vector) used to diffract the image light 5 in an angular range in which the first reflective hologram 221 diffracts the image light 5, are formed in the second reflective hologram 222. In the present embodiment, the second reflective hologram 222 corresponds to another diffractive optical element.

For example, when the real-image screen 210 displaying thereon the object image 1 is desired to be arranged in back in the apparatus, as viewed from the user 3, the virtual-image screen 220 that is transmissive in totality can be formed by using two reflective holograms that are the first and second reflective holograms 222 and 223.

In other words, the image light 5 passing through the fourth surface 224 and the third surface 223 (the first reflective hologram 221) and being incident on the fifth surface 225 is diffracted by the second reflective hologram 222 to exit the fifth surface 225, and is incident on the third surface 223. The image light 5 exits the third surface 223 in an exit direction (the horizontal direction in the figure) that is different from a specular-reflection direction that corresponds to a direction of incidence on the third surface 223. This enables the user 3 to observe the virtual image 2 through the virtual-image screen 220.

Here, for example, it is assumed that a position that is situated symmetrically with respect to the position P of the object image 1 (the real-image screen 210) relative to the first surface 211 is referred to as a virtual position (P″) of the object image 1, and a position of the virtual image 2 is referred to as a virtual-image position (P′). Further, an angle that is formed by a bisector of a line that connects the virtual position P″ and the virtual-image position P′, and the first surface 211 is referred to as an intersection angle α. On the basis of the intersection angle α, each reflective hologram is formed to satisfy the conditions described in the embodiment above.

For example, the boundary pitch Λ for the first reflective hologram 221 is set such that the intersection angle α is less than or equal to 16.3 degrees. Further, for example, the slant angle for the first reflective hologram 221 is set as appropriate such that the diffraction efficiency in the display elevation range exhibits a desired distribution.

This makes it possible to make the apparatus smaller in size in spite of the configuration in which two reflective holograms are used in combination, and to suppress a change in virtual image that is caused due to the movement of an observation direction to perform display of a virtual image with a sense of reality.

### Third Embodiment

FIG. 19 schematically illustrates an example of a configuration of an image display apparatus according to a third embodiment. A of FIG. 19 is a side view of an image display apparatus 300 as viewed from an X direction, and B of FIG. 19 is a top view of the image display apparatus 300 as viewed from a Y direction. The image display apparatus 300 includes a real-image screen 310 in the form of a flat plate, and a curved virtual-image screen 320. It can also be said that, for example, this configuration is a configuration in which the virtual-image screen 20 of the image display apparatus 100 described with reference to, for example, FIG. 1 is curved such that a convex side of the virtual-image screen 20 faces the user 3 corresponding to a visually recognizing person.

The virtual-image screen 320 includes a reflective hologram 321 and a transparent base material 330. The virtual-image screen 320 is formed by attaching the reflective hologram 321 to the transparent base material 330 curved about an axis in the Y direction such that a convex side of the transparent base material 330 faces the user 3.

In the example illustrated in FIG. 19, the reflective hologram 321 is arranged on a convex curved surface of the transparent base material 330. Without being limited thereto, for example, the reflective hologram 321 may be arranged on a concave inner surface of the transparent base material 330 (a surface that faces opposite to the user 3).

For example, the reflective hologram 321 produced (exposed to light) in the form of a flat plate can be used by being deformed into a curved shape. For example, when the reflective hologram 321 is a film, the reflective hologram 321 can be used by being bonded to the surface of the transparent base material 330 (such as a plastic molded product) including a transparent curved surface.

In any case, in the image display apparatus 300, a third surface 323 on which the image light 5 of the object image 1 is incident is arranged on the outside, and the virtual-image screen 320 is curved such that a convex side of the virtual-image screen 320 faces a visually recognizing person (the user 3). In other words, in the virtual-image screen 320, the third surface 232 facing the user 3 is an outer peripheral surface.

When the curvature of the virtual-image screen 320 is set as appropriate, this makes it possible to suppress a change in virtual image that is caused when an azimuth angle corresponding to an observation direction is changed due to a horizontal movement of a point of view. For example, the data 35e illustrated in FIG. 7 described above is data when a reflective hologram for which the boundary pitch Λ with α=16.3 degrees is set, is curved with a radius of curvature R of 200 mm. For example, there is a smaller change in virtual image when the curved virtual-image screen 320 is used (the data 35e), compared with a change in virtual image that is caused due to a change in azimuth angle when a virtual-image screen in the form of a flat plate is used (the data 35b).

Thus, for example, curving the virtual-image screen 320 produced in the form of a flat plate so that the virtual-image screen 320 has a curvature in the horizontal direction in which the convex side of the virtual-image screen 320 faces the user 3, is effective in suppressing, for example, the movement of a virtual image due to the horizontal movement of a face. Note that distortion of the virtual image 2 that is caused by curving the virtual-image screen 320 can be overcome by correcting in advance the object image 1 formed on the real-image screen 310.

As described above, the adoption of a curved screen of which a convex side faces a visually recognizing person makes it possible to achieve further improvement regarding a horizontal movement of a visual-recognition position.

Moreover, a hologram surface (the third surface 323 and a fourth surface 324) on the virtual-image screen 320 may also have any curved shape from the viewpoint of, for example, design. In this case, distortion of the virtual image 2 can be corrected by inversely distorting a video (the object image 1) on the side of the real-image screen 310.

### Fourth Embodiment

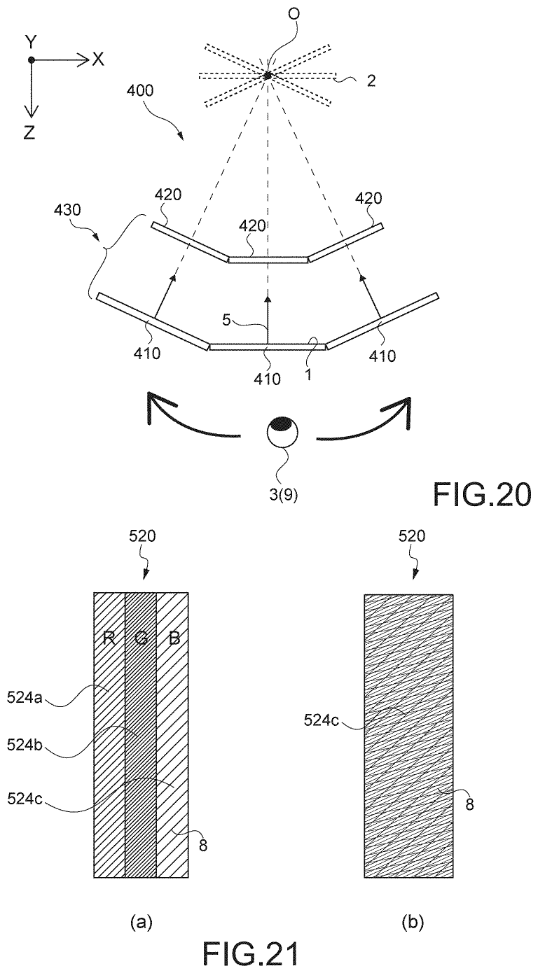

FIG. 20 schematically illustrates an example of a configuration of an image display apparatus according to a fourth embodiment. An image display apparatus 400 is formed by a plurality of pairs 430 of a real-image screen 410 and a virtual-image screen 420 being arranged such that the respectively displayed virtual images 2 overlap each other. For example, the pair 430 of the real-image screen 410 and the virtual-image screen 420 is arranged such that a central axis of the virtual image 2 that extends in parallel with the vertical direction (a Y direction) coincides with a specified reference axis O. A certain pair 430 of screens is arranged at a position to which another pair 430 of screens is displaced by being rotated about the reference axis O. The respective screens of the pair 430 of screens are configured similarly to the screens of the image display apparatus 100 described with reference to, for example, FIG. 1.

As described above, the image display apparatus 400 is an apparatus that includes a plurality of virtual-image screens 410 (real-image screens 420) used in combination by being arranged in the form of a cylinder. This makes it possible to display a virtual image in various directions around the image display apparatus 400.

In each pair 430 of screens, the boundary pitch Λ and the slant angle φ for a reflective hologram used as the virtual-image screen 410 are set as appropriate such that a change in virtual image can be suppressed.

This makes it possible to suppress a difference in a change in virtual image that is caused at a position at which the surface is switched, even if the azimuth angle corresponding to an observation direction is changed due to the point of view of the user 3 observing the image display apparatus 400 being moved about the reference axis O. In other words, it is possible to prevent the display position of the virtual image 2 from being discontinuously changed at a position at which the virtual-image screen 410 is switched. Consequently, a sense of reality with respect to the virtual image 2 is hardly reduced.

### Other Embodiments

The present technology is not limited to the embodiments described above, and can achieve various other embodiments.

In the embodiments above, the volume hologram only having the first order of diffraction has primarily been described as a reflective hologram. This is an example of a photopolymer phase modulating diffraction grating using a photosensitive photopolymer. Without being limited thereto, any phase modulating diffraction grating may be used. For example, a liquid-crystal phase modulating element in which the refractive index is changed using liquid crystal may be used. Further, a diffraction grating such as a phase hologram that forms a diffraction pattern using imprinting may be used. The use of imprinting makes it possible to reduce apparatus costs.

Moreover, a specific configuration of the hologram is not limited. For example, a material such as a photopolymer is selected according to a magnitude of a difference in refractive index with respect to a slant. In this case, for example, a material is selected that provides a difference in refractive index such that a necessary diffraction efficiency and a necessary diffraction-efficiency angular range are obtained. Further, the type of hologram may be selected as appropriate according to the manufacturability and costs.

The real-image screen may be configured as a multiview video source. The multiview video source is, for example, a video source that can display a different point-of-view image according to, for example, a viewing direction. The point-of-view images are, for example, images of a specified display target that are captured from various directions. For example, when point-of-view images are displayed in respective directions, this makes it possible to display a display-target stereo image. In this case, the virtual-image screen displays, as a virtual image, a stereo image displayed by the multiview video source.

For example, a multi-projector video source that displays a plurality of point-of-view images by projecting images using a plurality of projectors at different projection angles, is used as the multiview video source. Further, for example, an autostereoscopic display that displays a plurality of point-of-view images may be used. Example of the display include a lenticular-lens display, a lens-array display, and a parallax-barrier display. Moreover, a specific configuration of the multiview video source is not limited, and any video source may be used according to, for example, the application of the apparatus.

FIG. 21 schematically illustrates examples of configurations of virtual-image screens according to other embodiments. The example in which a virtual image is displayed in one color has primarily been described above. However, the present technology can also be applied to color display. FIG. 21 is a set of schematic cross-sectional views of a virtual-image screen 520 that deals with color display. When color display is performed, for example, light sources that respectively emit pieces of light of wavelengths of, for example, red, green, and blue that are necessary for color display (such as red light (R), green light (G), and blue light (B)) are provided as light sources of an object image (image light). Thus, the image light of the object image includes a plurality of pieces of colored light of wavelengths different from each other. The virtual-image screen 520 is configured such that the virtual-image screen 520 can diffract the respective pieces of colored light.

In (a) of FIG. 21, a plurality of reflective holograms 524a to 524c arranged in a layered formation is used as a diffractive optical element of the virtual-image screen 520, each of the reflective holograms 524a to 524c being a reflective hologram for which the boundary pitch Λ of the interference fringes 8 and the slant angle φ of the interference fringes 8 are set according to a corresponding one of the plurality of pieces of colored light. In other words, the diffractive optical element illustrated in (a) of FIG. 21 is formed by arranging a plurality of HOEs in a layered formation, each of the plurality of HOEs including the boundary pitch Λ and slant angle φ being designed for RGB corresponding to color wavelengths to be used.

The boundary pitches and the slant angles φ for the respective reflective holograms 524a, 524b, and 524c are respectively set to diffract the red light (R), the green light (G), and the blue light (B) in specified exit directions.

For example, the reflective holograms 524a, 524b, and 524c are generated by being exposed to pieces of light of red, green, and blue wavelengths to generate the interference fringes 8. Note that a wavelength of diffraction-target colored light and an exposure wavelength used to perform exposure to generate the interference fringe 8 do not necessarily have to be identical to each other. For example, the reflective hologram 524a diffracting the red light (R) may be exposed with a green wavelength. As described above, light of a wavelength identical to a wavelength of colored light to be used may be used as the exposure wavelength, or light of a wavelength other than the wavelength of the colored light may be used as the exposure wavelength.

Further, in the example illustrated in (a) of FIG. 21, the reflective holograms 524a, 524b, and 524c are arranged in a layered formation in this order. Note that the order of arranging the reflective holograms 524a to 524c in a layered formation is not limited.

When a plurality of reflective holograms 524 is used by being arranged in a layered formation, as described above, the boundary pitch Λ and the slant angle φ are set for each reflective hologram 524 according to the method described with reference to, for example, FIGS. 6 and 7. This makes it possible to display, for example, a color virtual image in which a change in virtual image that is caused due to the movement of an observation direction is sufficiently suppressed.

In (b) of FIG. 21, a single reflective hologram 524d on which multiple exposure is performed to generate the interference fringes 8 having the boundary pitches Λ and slant angles φ corresponding to respective pieces of colored light of a plurality of pieces of colored light is used as the diffractive optical element of the virtual-image screen 520.

A photopolymer or the like on which multiple exposure (simultaneous exposure) can be performed to generate the interference fringes 8 is used for the reflective hologram 524d, and, for example, a plurality of types of interference fringes 8 is generated by performing exposure under exposure conditions corresponding to the respective pieces of colored light. The boundary pitches Λ and the slant angles φ of the interference fringes 8 of the plurality of types of interference fringes 8 are designed to properly diffract pieces of light of the respective colors of R, G, and B.

This makes it possible to configure a single-layer reflective hologram 524d that deals with color display. This results in there being no need to, for example, arrange a plurality of holograms in a layered formation, and thus in being able to reduce apparatus costs.

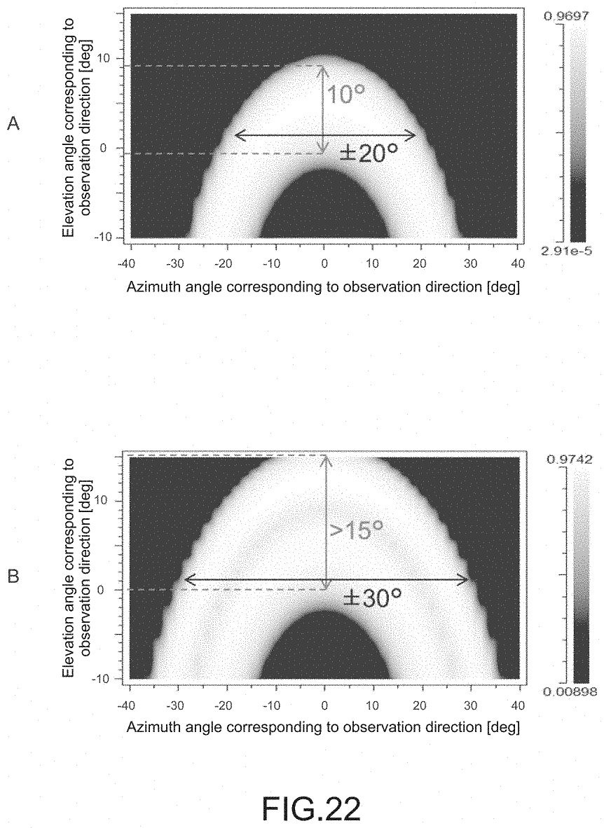

FIG. 22 is a set of maps of examples of distributions of diffraction efficiencies of virtual-image screens. Here, a method for broadening an angular range in an exit direction (the diffraction-efficiency angular range) is described, the angular range in an exit direction being a range in which the diffraction efficiency of a reflective hologram exhibits a value greater than or equal to a certain value. The diffraction-efficiency angular range is an example of the display angular range described above.

A of FIG. 22 is a map of an example of an angular distribution of a diffraction efficiency of a reflective hologram A for which a single slant angle φ is set. A vertical axis of the map represents an elevation angle corresponding to an exit direction of the image light 5 exiting the reflective hologram A, and a horizontal axis of the map represents an azimuth angle corresponding to the exit direction. Further, a color of each point represents the diffraction efficiency depending on the elevation angle and azimuth angle corresponding to the exit direction.

The reflective hologram A is a hologram that diffracts green light G and for which the boundary pitch Λ is set to 1200 nm and the slant angle φ is set to 78.3 degrees.

Ranges of an elevation angle and of an azimuth angle in which the diffraction efficiency exhibits a value greater than or equal to 80% of the peak value are hereinafter respectively referred to as a diffraction-efficiency elevation range and a diffraction-efficiency azimuth range.

As illustrated in A of FIG. 22, in the case of a virtual-image screen only using the reflective hologram A, the diffraction-efficiency elevation range when the azimuth angle=0 degrees is a range of about 10 degrees. Further, the diffraction-efficiency azimuth range when the elevation angle=2 degrees is a range of about +/−20 degrees.

B of FIG. 22 is a map of an example of an angular distribution of a diffraction efficiency of a virtual-image screen formed by arranging the reflective hologram A and a reflective hologram B in a layered formation.

The reflective hologram B is a hologram that diffracts the green light G and for which the boundary pitch Λ is set to 1200 nm and the slant angle φ is set to 77.95 degrees. In other words, the reflective hologram B is a hologram on which exposure is performed to generate interference fringes for which the boundary pitch Λ is the same as the reflective hologram A and the slant angle φ is changed.

As described above, in B of FIG. 22, a plurality of reflective holograms A and B being arranged in a layered formation and for which their boundary pitches Λ of the interference fringes 8 are equal and their slant angles φ of the interference fringes 8 are different from each other, is used as the diffractive optical element of the virtual-image screen.

The reflective hologram B has the boundary pitch Λ in common with the reflective hologram A, and this results in the reflective hologram B being a hologram that can diffract light of a wavelength identical to that of the reflective hologram A (here, the green light G). Further, the slant angle φ is changed, and this results in the reflective hologram B being a hologram of which a diffraction efficiency exhibits an angular distribution different from an angular distribution of a diffraction efficiency of the reflective hologram A.

Consequently, in the virtual-image screen obtained by arranging the reflective holograms A and B in a layered formation, the diffraction-efficiency elevation range when the azimuth angle=0 degrees is made larger up to a range of 15 degrees or greater, as illustrated in B of FIG. 22. Further, the diffraction-efficiency azimuth range when the elevation angle=2 degrees is made larger up to a range of about +/−28 degrees.

Further, a single reflective hologram C on which multiple exposure is performed to generate the interference fringes 8 such that the boundary pitches Λ of the interference fringes 8 are equal and the slant angles φ of the interference fringes 8 are different from each other, may be used as the diffractive optical element of the virtual-image screen.

Exposure is performed on the reflective hologram C to generate, for example, the interference fringes 8 having a slant angle φ of 78.3 degrees that is equal to the slant angle φ of the reflective hologram A, and the interference fringes 8 having a slant angle φ of 77.95 degrees that is equal to the slant angle φ of the reflective hologram B. This makes it possible to make the diffraction-efficiency angular range larger.

As described above, an angular range with diffraction efficiency can be broadened by reflective holograms for which a plurality of slant angles φ is set being arranged in a layered formation with a constant boundary pitch A, or by performing simultaneous exposure to generate the interference fringes 8 having a plurality of slant angles φ with a constant boundary pitch Λ. This makes it possible to broaden a visually recognizable angular range in which the user 3 can visually recognize the virtual image 2.

Note that the example of diffracting light of one color has been described in FIG. 22. When color display is performed, the diffraction-efficiency angular range can be broadened by using the method described above for each of the wavelengths of R, G, and B.

The configuration in which the direction of the period of the interference fringes 8 on the third surface (the incident surface) is parallel to a direction obtained by orthogonally projecting an incident direction of the image light 5 onto the third surface, has been described in the embodiments above (for example, refer to FIG. 3). Without being limited thereto, the direction of the period of the interference fringes 8 on the third surface may be set to be a direction that intersects the direction obtained by orthogonally projecting the incident direction onto the third surface.

For example, this is a configuration in which the reflective hologram 24 illustrated in FIG. 3 is rotated about an axis in the Z direction by a specified angle. In this case, the direction of the interference fringes 8 on the third surface 21 is a direction of the interference fringes 8 inclined with respect to the horizontal direction at an angle equal to the rotation angle.

The arrangement of the interference fringes 8 in the reflective hologram 24 illustrated in (b) of FIG. 3 is hereinafter referred to as a horizontal arrangement. Further, the arrangement of the reflective hologram in which the interference fringes 8 in the horizontal arrangement have been rotated about the axis in the Z direction, is hereinafter referred to as a rotation arrangement.

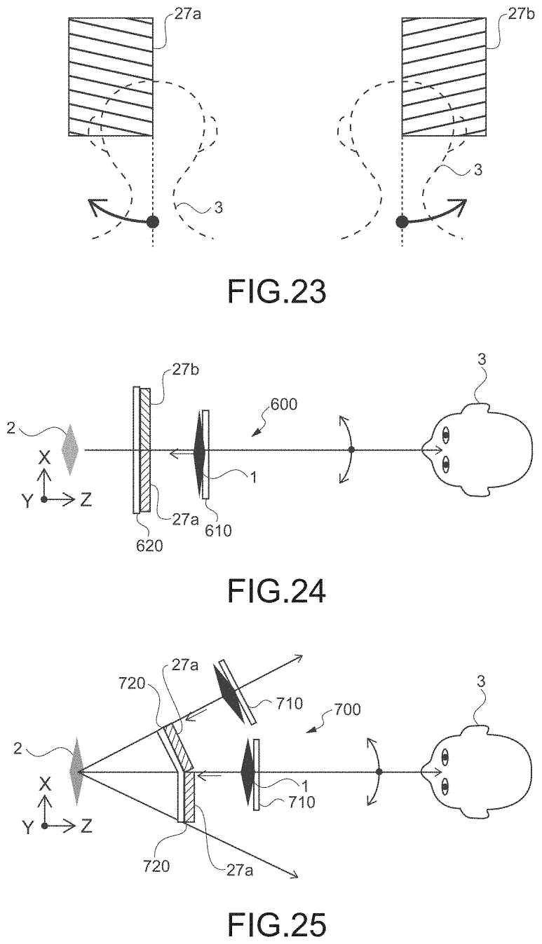

FIG. 23 schematically illustrates an example of a reflective hologram in the rotation arrangement. FIG. 23 schematically illustrates reflective holograms 27 each configured such that a direction of the interference fringes 8 is inclined with respect to the horizontal direction. Note that a reflective hologram 27a on the left and a reflective hologram 27b on the right in FIG. 23 have the interference fringes 8 of different inclination directions.

Here, it is assumed that the user 3 observes the reflective hologram from diagonally above at an angle with an elevation angle greater than or equal to 0 degrees.

The reflective hologram 27a illustrated on the left of FIG. 23 is in the rotation arrangement in which rotation is performed clockwise from the horizontal arrangement as viewed from the user 3, where the direction of the interference fringes 8 is inclined downward right from the upper left. A direction orthogonal to these interference fringes 8 (a direction inclined upward right from the lower left) is a period direction.

For example, it is assumed that the user 3 moves from the right to the left of the reflective hologram 27a in the rotation arrangement while looking at the center of the reflective hologram 27a.

This state corresponds to a state in which, with respect to the reflective hologram 24 in the horizontal arrangement (refer to B of FIG. 3), the user 3 looking at the center of the reflective hologram 24 from the diagonally upper right, moves his/her point of view downward left. In this case, the elevation angle corresponding to an observation direction as viewed from the center of the reflective hologram 24 in the horizontal arrangement becomes smaller as the point of view is moved further downward left.

Also in the case of the reflective hologram 27a in the rotation arrangement, the elevation angle corresponding to an observation direction using the interference fringes 8 for the reflective hologram 27a as a reference (such as an elevation angle in a plane orthogonal to the interference fringes 8) becomes smaller as the user 3 moves. Consequently, a change in virtual image is made smaller when the user 3 moves from the right to the left of the reflective hologram 27a.

In other words, a state in which the user is looking at the reflective hologram 27a from the right is a state in which an offset is added to an elevation angle corresponding to an observation direction. Since the offset of the elevation angle is reduced as the user 3 moves to the left, a change in virtual image is made smaller. Note that, after the change in virtual image becomes smallest, the offset of the elevation angle offset is increased again. This results in an increase in a change in virtual image.

Consequently, in the rotation arrangement, an angular range in which a change in virtual image can be suppressed is larger than an angular range in the horizontal arrangement in a direction in which the change in virtual image is suppressed. In other words, an observation range in which a change in virtual image is suppressed can be made larger by setting the interference fringes 8 in the rotation arrangement.

For example, the data 35f illustrated in FIG. 7 is data when the reflective hologram 24 in the horizontal arrangement for which the boundary pitch Λ when α=16.3 degrees is set, is rotated 10 degrees about the axis in the Z direction. For example, in a wide angular range, there is a smaller change in virtual image when the reflective hologram 27a in the rotation arrangement is used (the data 35e), compared with a change in virtual image that is caused due to a change in azimuth angle when the reflective hologram 24 in the horizontal arrangement is used (the data 35b).

The reflective hologram 27b illustrated on the right of FIG. 23 is in the rotation arrangement in which rotation is performed counterclockwise from the horizontal arrangement as viewed from the user 3, where the direction of the interference fringes 8 is inclined upward right from the lower left. A direction orthogonal to these interference fringes 8 (a direction inclined downward right from the upper left) is a period direction.

In the reflective hologram 27b, a change in virtual image is suppressed, for example, in a direction in which the user 3 moves from the left to the right of the reflective hologram 27b.

FIG. 24 schematically illustrates an example of a configuration of an image display apparatus using the reflective hologram 27 in the rotation arrangement. An image display apparatus 600 illustrated in FIG. 24 uses the reflective hologram 27a in which the interference fringes 8 are rotated clockwise as viewed from an observation direction, and the reflective hologram 27b in which the interference fringes 8 are rotated counterclockwise as viewed from the observation direction.

The image display apparatus 600 includes a real-image screen 610 in the form of a flat plate, and a virtual-image screen 620 in the form of a flat plate. The real-image screen 610 projects the object image 1 toward the center of the virtual-image screen 620 from diagonally below. The reflective holograms 27a and 27b in the rotation arrangement are adjacently arranged on the left and on the right of the virtual-image screen 620 as viewed from the user 3. The boundary of the reflective holograms 27a and 27b corresponds to a center line of the virtual-image screen 620.

For example, when the user 3 moves to the left from the center line, the reflective hologram 27a makes it possible to perform display, with a change in the virtual image 2 being suppressed. Conversely, when the user 3 moves to the right from the center line, the reflective hologram 27b suppresses the change in the virtual image 2. When the reflective hologram 27a in which the interference fringes 8 are rotated clockwise, and the reflective hologram 27b in which the interference fringes 8 rotated counterclockwise are used, as described above, this makes it possible to broaden an azimuth range in which a positional shift and an inclination of the virtual image 2 are reduced.

FIG. 25 schematically illustrates another example of the configuration of the image display apparatus using the reflective hologram 27 in the rotation arrangement. An image display apparatus 700 illustrated in FIG. 25 uses the reflective hologram 27a in which the interference fringes 8 are rotated clockwise as viewed from an observation direction.

The image display apparatus 700 includes a plurality of real-image screens 710 and a plurality of virtual-image screens 720. Each virtual-image screen 720 is formed using a reflective hologram 27a, and the virtual-image screens 720 are arranged adjacent to each other to form a specified angle such that an inner side of the virtual-image screen is on the side on which the virtual image 2 is displayed. In other words, a plurality of virtual-image screens 720 forms a multi-screen. A plurality of real-image screens 710 is arranged to surround the multi-screen (the virtual-image screens 720) to project the object image 1 centered on a right end of the reflective hologram 27a.

It can also be said that the image display apparatus 700 has a configuration obtained by removing the reflective hologram 27b from the image display apparatus 600 illustrated in FIG. 24 to obtain a unit, and by rotationally symmetrically arranging the unit.

Note that FIG. 25 illustrates an example of forming a two-sided screen using two virtual-image screens 620. Without being limited thereto, a multi-screen with two or more sides may be formed. Further, the image display apparatus may be formed by a unit that includes the reflective hologram 27b being rotationally symmetrically arranged.

For example, when the user 3 moves to the left of a boundary of the virtual-image screens 720, as illustrated in FIG. 25, the reflective hologram 27a arranged on the left of the boundary suppresses a change in the virtual image 2. Further, when the user 3 moves from the boundary to the right, the virtual image 2 is displayed by the next reflective hologram 27a arranged on the right of the boundary.

Here, an angular width of an azimuth angle in which the virtual image 2 is observed through the reflective hologram 27a on the right is equal to an angular width in the reflective hologram 27a on the left. Thus, a change in the virtual image 2 is also suppressed in the reflective hologram 27a on the right, as in the reflective hologram 27b on the left.

As described above, the image display apparatus 700 makes it possible to keep a state in which a change in virtual image is sufficiently suppressed, until the panel displaying the virtual image 2 is switched. This makes it possible to perform image display that is visible from all directions with a sense of reality, with a change in virtual image being sufficiently suppressed.

At least two of the features of the present technology described above can also be combined. In other words, the various features described in the respective embodiments may be combined discretionarily regardless of the embodiments. Further, the various effects described above are not limitative but are merely illustrative, and other effects may be provided.

In the present disclosure, expressions such as “same”, “equal”, “orthogonal”, and “parallel” include, in concept, expressions such as “substantially the same”, “substantially equal”, “substantially orthogonal”, and “substantially parallel”. For example, the expressions such as “same”, “equal”, “orthogonal”, and “parallel” also include states within specified ranges (such as a range of +/−10%), with expressions such as “exactly the same”, “exactly equal”, “completely orthogonal”, and “completely parallel” being used as references.

Note that the present technology may also take the following configurations.

(1) An image display apparatus, including:

a first screen that includes an image surface on which an object image is formed, the first screen obliquely projecting the object image from the image surface; and

a second screen that includes an incident surface that is arranged parallel to the image surface and on which image light of the object image is incident, the second screen diffracting the image light in an exit direction different from a specular-reflection direction that corresponds to a direction of incidence of the image light on the incident surface, the second screen forming a virtual image parallel to the object image.

(2) The image display apparatus according to (1), in which

the second screen includes a reflective diffractive optical element that diffracts the image light incident on the incident surface and causes the image light to exit the incident surface.

(3) The image display apparatus according to (2), in which

the diffractive optical element is a holographic optical element on which exposure is performed to generate interference fringes having a period in a certain direction.

(4) The image display apparatus according to (3), in which

the certain direction of the period of the interference fringes on the incident surface is a direction obtained by orthogonally projecting the incident direction onto the incident surface.

(5) The image display apparatus according to (3) or (4), in which

a boundary pitch of the interference fringes is set such that an angle formed by the holographic optical element and a bisector of a line that connects the object image and the virtual image displayed to be oriented toward the exit direction is less than or equal to 16.3 degrees.

(6) The image display apparatus according to any one of (3) to (5), in which

a slant angle of the interference fringes is set to one of an angle in which the image light diffracted under a Bragg condition is within an elevation range used to display the virtual image, and an angle in which only the image light diffracted under a condition in which the Bragg condition is intendedly not adopted, is within the elevation range.

(7) The image display apparatus according to any one of (3) to (6), in which

the image light of the object image includes a plurality of pieces of colored light of wavelengths different from each other, and

the diffractive optical element is one of a plurality of the holographic optical elements arranged in a layered formation, each of the plurality of the holographic optical elements being a holographic optical element for which a boundary pitch of the interference fringes and a slant angle of the interference fringes are set according to a corresponding one of the plurality of pieces of colored light, and the holographic optical element on which multiple exposure is performed to generate the interference fringes having the boundary pitches and slant angles corresponding to respective pieces of colored light of the plurality of pieces of colored light.

(8) The image display apparatus according to any one of (3) to (7), in which

the diffractive optical element is one of a plurality of the holographic optical elements being arranged in a layered formation and for which respective boundary pitches of the interference fringes are equal and respective slant angles of the interference fringes are different from each other, and the holographic optical element on which multiple exposure is performed to generate the interference fringes such that the boundary pitches of the interference fringes are equal and the slant angles of the interference fringes are different from each other.

(9) The image display apparatus according to any one of (3) to (8), in which

the second screen includes another reflective diffractive optical element that is arranged across the diffractive optical element from the first screen, the other diffractive optical element diffracting the image light passing through the diffractive optical element, the other diffractive optical element causing the image light to exit the second screen to be headed for the diffractive optical element.

(10) The image display apparatus according to any one of (3) to (9), in which

the direction of the period of the interference fringes on the incident surface is a direction that intersects a direction obtained by orthogonally projecting the incident direction onto the incident surface.

(11) The image display apparatus according to any one of (1) to (10), in which

the exit direction is set to be a direction orthogonal to the incident surface.

(12) The image display apparatus according to (11), in which

the first and second screens are arranged in a vertical direction, and

the exit direction is set to be a horizontal direction.

(13) The image display apparatus according to any one of (1) to (12), in which

the first screen is arranged diagonally below or diagonally above a region on the incident surface, the region being a region onto which the image light of the object image is projected.

(14) The image display apparatus according to any one of (1) to (13), in which

the second screen is in the form of a flat plate, or is curved such that a convex side of the second screen faces a visually recognizing person.

(15) The image display apparatus according to any one of (1) to (14), in which

the first screen is a diffusion screen, and

the image display apparatus further includes a projection section that projects the image light of the object image onto the diffusion screen.

(16) The image display apparatus according to any one of (1) to (14), in which

the first screen is a display that is capable of displaying thereon the object image.

(17) The image display apparatus according to any one of (1) to (16), in which

a light source of the image light is one of at least one single-wavelength light source that emits light of a different wavelength, and at least one narrowband light source that emits light of a different wavelength.

### REFERENCE SIGNS LIST

1 object image
2, 2a to 2c virtual image
3 user
5 image light
7 specular-reflection direction
8 interference fringe
10, 10a to 10c, 210, 310, 410, 610, 710 real-image screen
11, 11a to 11c, 211 first surface
15 projector
20, 220, 320, 420, 520, 620, 720 virtual-image screen
21, 223, 323 third surface
24, 27, 321 reflective hologram
100, 200, 300, 400, 600, 700 image display apparatus

What is claimed is:

1. An image display apparatus, comprising:
a first screen that includes an image surface on which an object image is formed, the first screen obliquely projecting the object image from the image surface; and
a second screen that includes an incident surface that is arranged parallel to the image surface and on which image light of the object image is incident, the second screen diffracting the image light in an exit direction different from a specular-reflection direction that corresponds to a direction of incidence of the image light on the incident surface, the second screen forming a virtual image parallel to the object image.

2. The image display apparatus according to claim 1, wherein
the second screen includes a reflective diffractive optical element that diffracts the image light incident on the incident surface and causes the image light to exit the incident surface.

3. The image display apparatus according to claim 2, wherein
the diffractive optical element is a holographic optical element on which exposure is performed to generate interference fringes having a period in a certain direction.

4. The image display apparatus according to claim 3, wherein
the certain direction of the period of the interference fringes on the incident surface is a direction obtained by orthogonally projecting the incident direction onto the incident surface.

5. The image display apparatus according to claim 3, wherein
a boundary pitch of the interference fringes is set such that an angle formed by the holographic optical element and a bisector of a line that connects the object image and the virtual image displayed to be oriented toward the exit direction is less than or equal to 16.3 degrees.

6. The image display apparatus according to claim 3, wherein
a slant angle of the interference fringes is set to one of an angle in which the image light diffracted under a Bragg condition is within an elevation range used to display the virtual image, and an angle in which only the image light diffracted under a condition in which the Bragg condition is intendedly not adopted, is within the elevation range.

7. The image display apparatus according to claim 3, wherein
the image light of the object image includes a plurality of pieces of colored light of wavelengths different from each other, and
the diffractive optical element is one of a plurality of the holographic optical elements arranged in a layered formation, each of the plurality of the holographic optical elements being a holographic optical element for which a boundary pitch of the interference fringes and a slant angle of the interference fringes are set according to a corresponding one of the plurality of pieces of colored light, and the holographic optical element on which multiple exposure is performed to generate the interference fringes having the boundary pitches and slant angles corresponding to respective pieces of colored light of the plurality of pieces of colored light.

8. The image display apparatus according to claim 3, wherein
the diffractive optical element is one of a plurality of the holographic optical elements being arranged in a layered formation and for which respective boundary pitches of the interference fringes are equal and respective slant angles of the interference fringes are different from each other, and the holographic optical element on which multiple exposure is performed to generate the interference fringes such that the boundary pitches of the interference fringes are equal and the slant angles of the interference fringes are different from each other.

9. The image display apparatus according to claim 3, wherein
the second screen includes another reflective diffractive optical element that is arranged across the diffractive optical element from the first screen, the other diffractive optical element diffracting the image light passing through the diffractive optical element, the other diffractive optical element causing the image light to exit the second screen to be headed for the diffractive optical element.

10. The image display apparatus according to claim 3, wherein
the direction of the period of the interference fringes on the incident surface is a direction that intersects a direction obtained by orthogonally projecting the incident direction onto the incident surface.

11. The image display apparatus according to claim 1, wherein
the exit direction is set to be a direction orthogonal to the incident surface.

12. The image display apparatus according to claim 11, wherein
the first and second screens are arranged in a vertical direction, and
the exit direction is set to be a horizontal direction.

13. The image display apparatus according to claim 1, wherein
the first screen is arranged diagonally below or diagonally above a region on the incident surface, the region being a region onto which the image light of the object image is projected.

14. The image display apparatus according to claim 1, wherein
the second screen is in the form of a flat plate, or is curved such that a convex side of the second screen faces a visually recognizing person.

15. The image display apparatus according to claim 1, wherein
the first screen is a diffusion screen, and
the image display apparatus further comprises a projection section that projects the image light of the object image onto the diffusion screen.

16. The image display apparatus according to claim 1, wherein
the first screen is a display that is capable of displaying thereon the object image.

17. The image display apparatus according to claim 1, wherein
a light source of the image light is one of at least one single-wavelength light source that emits light of a different wavelength, and at least one narrowband light source that emits light of a different wavelength.
